(19) United States
(12) Patent Application Publication
(10) Pub. No.: US 2011/0225117 A1
(43) Pub. Date: Sep. 15, 2011

(54) MANAGEMENT SYSTEM AND DATA ALLOCATION CONTROL METHOD FOR CONTROLLING ALLOCATION OF DATA IN STORAGE SYSTEM

(75) Inventors: Yuki NAKANISHI, Kawasaki (JP); Yasutaka Kono, Yokohama (JP); Yukinori Sakashita, Sagamihara (JP)

(73) Assignee: Hitachi, Ltd.

(21) Appl. No.: 12/780,578

(22) Filed: May 14, 2010

(30) Foreign Application Priority Data
Mar. 9, 2010 (JP) 2010-051577

(51) Int. Cl. G06F 17/30; G06F 9/50

(52) U.S. Cl. 707/602; 718/104; 707/E17.005

(57) ABSTRACT

A storage system includes a plurality of types of media and a controller, provides a plurality of logical volumes, and performs a reallocation process for migrating data specified in accordance with a reallocation policy from media in which this data is stored to media of different types from the media. A management system searches for a logical volume that conforms to a migration policy, which is a condition under which the reallocation process is considered ineffective, from a reallocation group, which is a group of one or more logical volumes subjected to a target of a reallocation process, and causes the storage system to transfer data in the logical volume that is discovered to outside of the reallocation group.

### CROSS-REFERENCE TO PRIOR APPLICATION

This application relates to and claims priority from Japanese Patent Application No. 2010-51577, filed on Mar. 9, 2010, the entire disclosure of which is incorporated herein by reference.

### BACKGROUND

The present invention generally relates to controlling the allocation of data in a storage system.

Reducing the operating costs of storage systems configured from one or more storage subsystems has become an important challenge in recent years. One method for solving this problem is data reallocation. In accordance with data reallocation, data is migrated from a storage area inside a storage subsystem to another storage area inside either the same or another storage subsystem in accordance with the data newness and frequency of use.

In general, in accordance with data migration, data is migrated from a logical volume in a migration source to a logical volume in a migration destination. The migration-destination logical volume may be a logical volume inside the storage subsystem that comprises the migration-source logical volume (Refer to Japanese Patent Application Laid-open No. 2000-293317) or may be a logical volume inside a storage subsystem other than this storage subsystem (Refer to U.S. Pat. No. 6,108,748 and Japanese Patent Application Laid-open No. 2003-345522).

Data migration may be automatically performed based on logical volume performance information or I/O (Input/Output) frequency (Refer to Japanese Patent Application Laid-open No. 2003-067187). Further, data migration may be performed in units of segments, which configure the logical volume (Refer to Japanese Patent Application Laid-open No. 2007-066259). As used here, “segment” refers to a logical storage area.

### SUMMARY

A logical volume is generally constructed based on attribute values, such as capacity, performance, and cost (for example, the so-called bit cost), which have been estimated beforehand by the user. Ordinarily, the estimated attribute values are higher than the attribute values actually required, and therefore, the logical volume attribute values are often wastefully excessive.

As a method for solving this problem, the dynamic reallocation of data (hereinafter, dynamic reallocation) is conceivable. According to one example of dynamic reallocation, data is reallocated in accordance with the I/O frequency of this data.

However, with dynamic reallocation alone, a case can arise in which the allocation of the data is inappropriate for the storage system as a whole. For example, a case can arise in which dynamic reallocation is regarded being ineffective. As an example of such a case, there is a case in which practically most of the data inside a certain logical volume is not reallocated (for example, a case in which the frequency of I/Os from the host device is fixed). In a case like this, the data will remain in the same storage area forever without being reallocated, and even though there is another logical volume whose performance can be expected to improve in a case where data is allocated to this storage area, the performance of this other logical volume is unable to be improved to the extent anticipated. Further, there are cases where the number and/or capacity of the logical volume(s) targeted for dynamic reallocation are limited. In accordance with this, a logical volume for which dynamic reallocation is regarded as being ineffective will continue to be targeted for dynamic reallocation, and as such, there is the likelihood that it will not be possible to target another logical volume for dynamic reallocation.

Accordingly, an object of the present invention is to exercise control such that data is allocated appropriately with respect to the storage system as a whole.

A storage system comprises a plurality of types of media and a controller, provides a plurality of logical volumes, and performs a reallocation process, which migrates data specified in accordance with a reallocation policy from media in which this data is stored to media of types differing from the media. A management system:

(A) retrieves, from a reallocation group, which is a group of one or more logical volumes subjected to a target of a reallocation process, a logical volume that conforms to a migration policy, which is a condition under which the reallocation process is regarded as being ineffective; and
(B) causes the storage system to execute an operation that transfers the data inside the logical volume discovered in the above-mentioned (A) to outside the reallocation group.

The management system may exist outside or inside the storage system. In the case of the latter, it is possible, for example, to treat the controller of the storage system as the management system.

The processing of (B), for example, may be any one of the following (b1) through (b3).

(b1) The migration of data inside a logical volume (VOL) 01 discovered in the above-mentioned (A) to a VOL (a VOL 10 outside of the reallocation group 3001) that was prepared from the start (Refer to FIG. 13A),
(b2) the identification, from a plurality of physical resources (a plurality of physical resources of the storage system), of a physical resource 3000 that is not related to VOLs 00 and 01, which are included in the reallocation group 3001, the construction of a new VOL 11 that is based on the identified physical resource 3000, and the migration of the data inside the VOL 01 discovered in accordance with the above-mentioned (A) to the above-mentioned newly constructed VOL 11 (Refer to FIG. 30B), and
(b3) the removal of the VOL 01 discovered in the above-mentioned (A) from the reallocation group 3001 (Refer to FIG. 30C).

For example, in Thin Provisioning, the above-mentioned either (b1) or (b2) is considered more effective than the above-mentioned (b3) in an aspect that reduces the size of the mapping table that shows the corresponding relationship between a virtual area and a real area.

The management system, for example, comprises (1) configuration management information, which is information related to the plurality of logical volumes provided by the storage system, (2) reallocation group information, which is information denoting the reallocation group, which is the group of one or more logical volumes that are the target of the reallocation process, and (3) migration policy information, which is information denoting the migration policy, which is the condition in accordance with which the reallocation process is regarded as being ineffective. The management system is able to identify an originally prepared logical volume outside of the reallocation group based on the configuration management information and the reallocation group information. The management system is also able to identify a physical resource that is not related to the reallocation group on the basis of the reallocation group information. Further, the management system is able to remove the logical volume discovered in the above-mentioned (A) from the reallocation group by removing the information related to the logical volume discovered in the above-mentioned (A) from the reallocation group information.

The storage system may be configured from one or more storage subsystems. In this case, the migration-destination logical volume may exist in a storage subsystem other than the storage subsystem that comprises the migration-source logical volume. Further, in this case, the storage subsystem that comprises the migration-source logical volume is the subsystem comprising the function for performing the above-mentioned reallocation process, but the storage subsystem that comprises the migration-destination logical volume may or may not comprise the function for performing the above-mentioned reallocation process.

The reallocation group may be formed as a pool (and a virtual volume to which a real area is allocated from this pool), which will be explained below.

The reallocation group may also be formed as a single storage subsystem. In a case where all of the one or more logical volumes configuring the reallocation group exist in one storage subsystem, a logical volume that is not included in the reallocation group is a logical volume inside a storage subsystem other than this storage subsystem.

Further, the reallocation process may be performed in volume units, and may also be performed in real area units. In a volume-unit reallocation process, a data migration is performed from a first logical volume to a second logical volume. In a real-area-unit reallocation process, data inside a first real area, which has been allocated to a first virtual area inside a first virtual volume, is migrated to a second real area inside a pool that is associated with the first virtual volume, and, in addition, the second real area is allocated to the first virtual area instead of the first real area. The first virtual volume, for example, is a virtual logical volume in accordance with Thin Provisioning. The virtual area is a virtual storage area, and the real area is a substantial storage area. The pool is a set of a plurality of real areas.

According to the present invention, the allocation of data can be made appropriate for the entire storage system.

### BRIEF DESCRIPTION OF THE DRAWINGS

FIG. 1 shows the configuration of a data processing system related to Example 1 of the present invention;

FIG. 2 shows the configuration of a volume table 12101;

FIG. 3 shows the configuration of a pool table 12102;

FIG. 4 shows the configuration of a physical resource table 12103;

FIG. 5 shows the configuration of a physical resource allocation table 12104;

FIG. 6 shows the configuration of a volume allocation table 12105;

FIG. 7 shows the configuration of a configuration information table 41001;

FIG. 8 shows the configuration of a policy table 41002;

FIG. 9 shows the sequence of a migration policy setting process;

FIG. 10 shows a first UI 1000, which is displayed in Step S1000 of FIG. 9;

FIG. 11 shows a second UI 2000;

FIG. 12 shows the sequence of a configuration information acquisition process;

FIG. 13 shows the sequence of a migration target determination process;

FIG. 14 shows the sequence of a migration instruction process;

FIG. 15 shows a third UI 3000, which is displayed in Step S4040;

FIG. 16 shows the sequence of a migration-destination decision process;

FIG. 17 shows the sequence of a volume migration process;

FIG. 18 shows the sequence of an I/O control process;

FIG. 19 shows the sequence of a segment migration instruction process;

FIG. 20 shows the sequence of a segment migration process;

FIG. 21 shows the sequence of a segment unit I/O control process;

FIG. 22 shows the configuration of a data processing system related to Example 2 of the present invention;

FIG. 23 shows the sequence of a migration destination decision process related to the Example 2;

FIG. 24 shows the configuration of a data processing system related to Example 3 of the present invention;

FIG. 25 shows the configuration of a volume table 12101c related to Example 3;

FIG. 26 shows the configuration of a configuration information table 41001c related to Example 3;

FIG. 27 shows the sequence of a configuration information acquisition process related to Example 3;

FIG. 28 shows the sequence of a volume performance monitoring process;

FIG. 29 shows the sequence of a migration destination decision process related to Example 3;

FIG. 30A shows Example 1 of transferring data outside of the reallocation group;

FIG. 30B shows Example 2 of transferring data outside of the reallocation group; and

FIG. 30C shows Example 3 of transferring data outside of the reallocation group.

### DETAILED DESCRIPTION OF THE EMBODIMENT

A number of examples of the present invention will be explained below.

In the following explanations, various type of information will be explained using the expression “xxx table”, but this information may be expressed using a data structure other than a table. To show that the information is not dependent on the data structure, “xxx table” may be called “xxx information”.

Further, an ID (identifier), a number and the like will be used as information for identifying one or another target in the following explanation, but the present invention is not limited to this, and other types of identification information may be used.

In the following explanation, there may be instances when “program” is used as the subject in explaining a process, but since a prescribed process is performed in accordance with a program being executed by a processor (for example, a CPU (Central Processing Unit)) while using a storage resource (for example, a memory) and/or communication interface processor (for example, a communication port) as needed, the subject of the process may also be the processor. A process that is explained having the program as the subject may be a process that is performed by a management system. The processor may comprise a hardware circuit for processing either all or a portion of the processes performed by the processor. A computer program may be installed in the respective computers from a program source. The program source, for example, may be a program delivery server or a storage medium.

A management system may be configured using one or more computers. Specifically, for example, in a case where a management computer displays information, or a case where the management computer sends display information to a remote computer, the management computer is the management system. Further, for example, in a case where the same functions as those of the management computer are realized by a plurality of computers, this plurality of computers (may include a display computer in a case where the display computer carries out displays) is the management system.

### Example 1

### Overview of Example 1

A logical volume that is the target of a dynamic reallocation is a virtual logical volume (hereinafter, virtual volume) that conforms to Thin Provisioning. A condition related to a virtual volume in accordance with which dynamic reallocation is regarded as being ineffective is set as a migration policy. The migration policy, for example, includes conditions, such as the frequency (the unit, for example, is IOPS (Input Output Per Second)) of I/O from the host computer to the virtual volume and the type of media to which the data has been allocated. A migration-source virtual volume is selected based on this migration policy. A migration-destination logical volume is a logical volume that is not the target of a dynamic reallocation, that is, a logical volume that is based on a physical resource (for example, a RAID group configured from a plurality of physical storage devices).

### <Configuration of Data Processing System Related to Example 1>

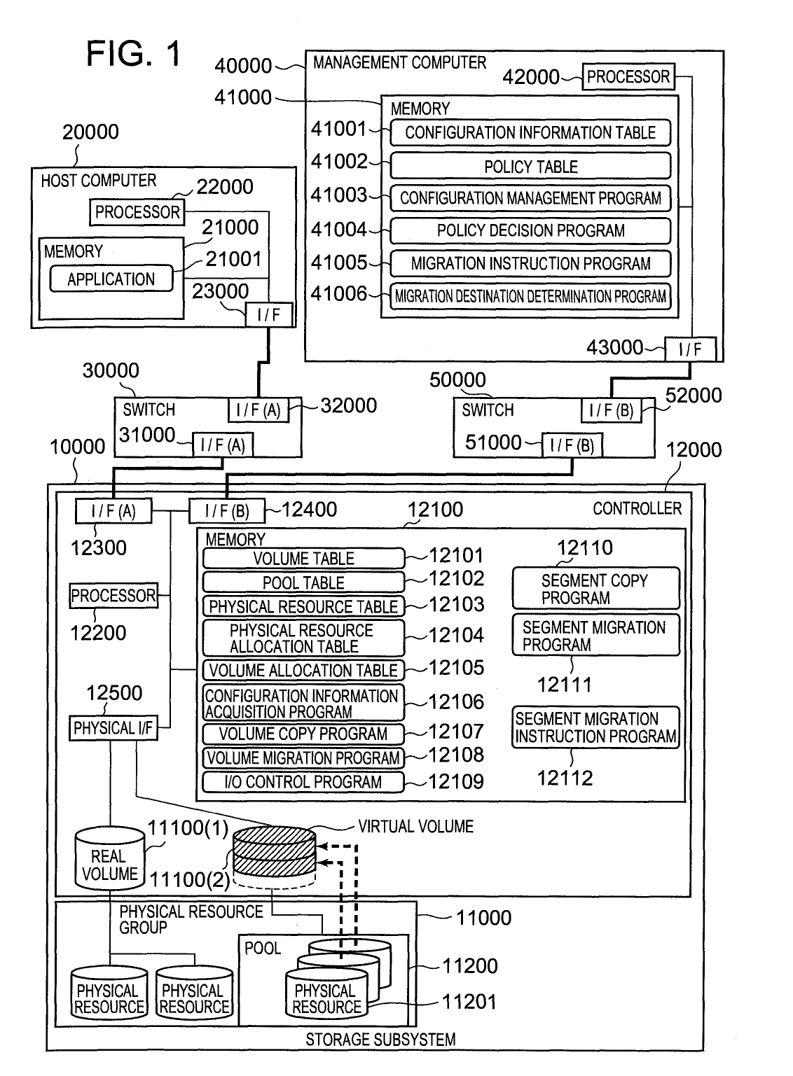

FIG. 1 shows the configuration of a data processing system related to Example 1 of the present invention. In the following explanation, a communication interface device will be abbreviated as “I/F”.

The data processing system comprises a storage subsystem 10000, a host computer 20000, a switch 30000, a management computer 40000, and a switch 50000. One each of the storage subsystem 10000, the host computer 20000, the switch 30000, the management computer 40000, and the switch 50000 are shown, but the number of these elements is not limited to one, and there may be two or more of each.

The storage subsystem 10000 and the host computer 20000 are network-coupled via the switch 30000. Further, the storage subsystem 10000 and the management computer 40000 are network-coupled via the switch 50000. The switch 30000 and the switch 50000 may be the same type device or may be different type devices. For example, the switch 30000 may be a FC (Fibre Channel) switching device serving as an element of a SAN (Storage Area Network), and the switch 50000 may be a router serving as an element of a LAN (Local Area Network).

The storage subsystem 10000 comprises a physical resource group 11000, and a controller 12000.

The physical resource group 11000 comprises a plurality of physical resources 11201. As used here, the physical resource 11201 may be a stand-alone physical storage device, and may be a RAID (Redundant Array of Independent (or Inexpensive) Disks) group configured from a plurality of the same type of physical storage devices. The types of physical storage devices may include a SSD (Solid State Drive), a SAS (Serial Attached SCSI)-HDD (Hard Disk Drive), and a SATA (Serial ATA)-HDD.

A pool 11200 is configured on the basis of one or more physical resources 11201. The pool 11200 is a storage area configured from a plurality of segments. A segment is a real area (a substantial storage area) that is based on one or more physical resources 11201. A segment is allocated from the pool 11200 to a virtual volume 11100 (2).

The pool 11200 comprises a plurality of segment groups featuring different performance. Each segment group is configured from one or more segments, and the performance is based on the same one or more physical resources 11201. The performance is a function of at least one of a media type, a RAID level, and a RAID group configuration (combination). In this example, it is supposed that the performance is a function solely of the media type. For example, a SSD-based segment features higher performance than a segment that is based on a SAS-HDD and SATA-HDD.

One pool 11200 and five physical resources 11201 are shown in the drawing, but these elements are not limited to these numbers.

The controller 12000 comprises a memory 12100, a processor 12200, an I/F (A) 12300, an I/F (B) 12400, and a physical I/F 12500. These elements, for example, are coupled by way of a bus. Another type of physical storage resource may be used either instead of or in addition to the memory 12100.

The I/F (A) 12300 is an I/F for communicating using a first communication protocol (for example, a FC (Fibre Channel) protocol), and is coupled to an I/F 23000 of the host computer 20000 via the switch 30000.

The I/F (B) 12400 is an I/F for communicating using a second communication protocol (for example, a TCP/IP (Transmission Control Protocol/Internet Protocol)), and is coupled to an I/F 43000 of the management computer 40000 via the switch 50000.

The physical I/F 12500 is the I/F for communicating using a third communication protocol (for example, a FC (Fibre Channel) protocol), and is coupled to the respective physical resources 11201.

The controller 12000 manages the logical volume 11100. The logical volume 11100 is a logical storage device that is provided to the host computer 20000. The logical volume 11100 may include a real volume 11100 (1) and a virtual volume 11100 (2).

The real volume 11100 (1) is a logical volume that is based on a physical resource 11201. Therefore, the capacity of the real volume 11100 (1) is equivalent to the capacity of a storage space part that is utilized by the real volume 11100 (1) of one or more physical resources 11201.

The virtual volume 11100 (2) is a logical volume that is not base on the physical resource 11201, and, specifically, is a virtual logical volume that conforms to Thin Provisioning. The virtual volume 11100 (2) is configured from a plurality of virtual areas (virtual storage areas). In a case where the controller 12000 receives a write request from the host computer 20000 specifying the virtual volume 11100 (2), and a segment has not been allocated to the write-destination virtual area identified from this write request, an unused segment (a segment that is not allocated to any virtual area) is allocated from the pool 11200 to the write-destination virtual area, and write-targeted data that accords with the write request is written to this segment. The storage capacity of the virtual volume 11100 (2) may be larger than the total capacity (used capacity) of the one or more segments that are actually allocated. In this example, a dynamic reallocation is performed in segment units in accordance with a program (to be described later) stored inside the memory 12100 being executed by the processor 12200. The dynamic reallocation is performed based on the I/O frequency of each virtual area, but either instead of or in addition to this, the dynamic reallocation may be performed based on another attribute value with respect to each virtual volume (for example, the importance of the data, and the time of the last I/O). In accordance with the dynamic reallocation, for example, it is possible for data inside a virtual area with a high IOPS to be allocated to a high-performance segment (a segment based on a physical resource featuring high performance), and for data inside a virtual area with a low IOPS to be allocated to a low-performance segment (a segment based on a physical resource featuring low performance). In accordance with this, it becomes possible for the user (the storage administrator) to appropriately allocate data without estimating the attribute values (for example, capacity, performance, and cost) related to the logical volume.

In FIG. 1, there is one real volume 11100 (1) and one virtual volume 11100 (2), but there may be two or more of both. In the following explanation, in a case where there is no particular distinction made between the real volume 11100 (1) and the virtual volume 11100 (2), these elements will be referred to generically as the “logical volume 11100”.

The memory 12100 stores programs and data that are used by the processor 12200. For example, the memory 12100 comprises a volume table 12101, a pool table 12102, a physical resource table 12103, a physical resource allocation table 12104, a volume allocation table 12105, a configuration information acquisition program 12106, a volume copy program 12107, a volume migration program 12108, an I/O control program 12109, a segment copy program 12110, a segment migration program 12111, and a segment migration instruction program 12112.

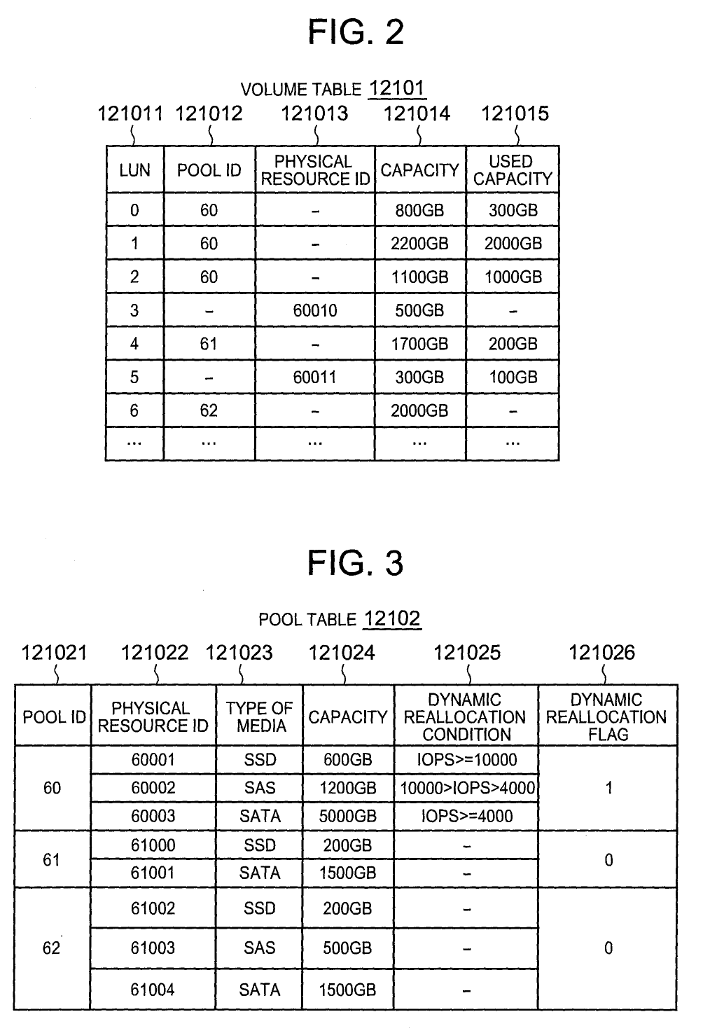

The volume table 12101 is for storing information related to all the logical volumes 11100 of the storage subsystem 10000. FIG. 2 shows a specific example. The volume table 12101 comprises the following information for each logical volume 11100.

(*) A LUN (Logical Unit Number) 121011, which is an identifier for identifying a logical volume,
(*) a pool ID 112012, which is the identifier for identifying the pool to which the virtual volume 11100 (2) belongs,
(*) a physical resource ID 121013, which is the identifier for identifying the physical resource 11201 on which the real volume 11100 (1) is based,
(*) a capacity 121014, which is information showing the capacity of the logical volume 11100, and
(*) a used capacity 121015, which is information showing the capacity utilization of the logical volume 11100.

The “used capacity” is the amount of data stored in the logical volume 11100. The used capacity 121015 is expressed in units of GB (gigabytes), but a hyphen (-) signifies 0 GB. The used capacity 121015 unit may be a ratio unit (for example, a % (percent)) instead of a unit of capacity like a GB. For example, the used capacity may be the total amount of data inside the logical volume 11100, or the percentage of the total amount of data with respect to the capacity of the logical volume 11100.

The pool table 12102 is for storing information related to all the pools 11200 of the storage subsystem 10000. FIG. 3 shows a specific example. The pool table 12102 comprises the following information for each pool 11200.

(*) A pool ID 121021, which is the identifier for identifying the pool 11200,
(*) a physical resource ID 121022, which is the identifier of the physical resource 11201 that configures the pool 11200,
(*) a media type 121023, which is information denoting the type of the physical storage device (the media type) that configures the physical resource 11201,
(*) a capacity 121024, which is information showing the capacity of the physical resource 11201,
(*) a dynamic reallocation condition 121025, which is information showing a dynamic reallocation condition, and
(*) a dynamic reallocation flag 121026, which denotes whether or not the pool 11200 is to undergo dynamic reallocation.

With regard to the flag 121026, ON (1) signifies that the pool 11200 is the target of a dynamic reallocation, and OFF (0) signifies that the pool 11200 is not the target of a dynamic reallocation.

In this example, the media types include a SSD, a SAS-HDD and a SATA-HDD, but another media type may be used either instead of or in addition to at least one of these.

The dynamic reallocation condition is defined as the range of I/O frequencies (the unit is IOPS), but this condition is not limited to the I/O frequency range.

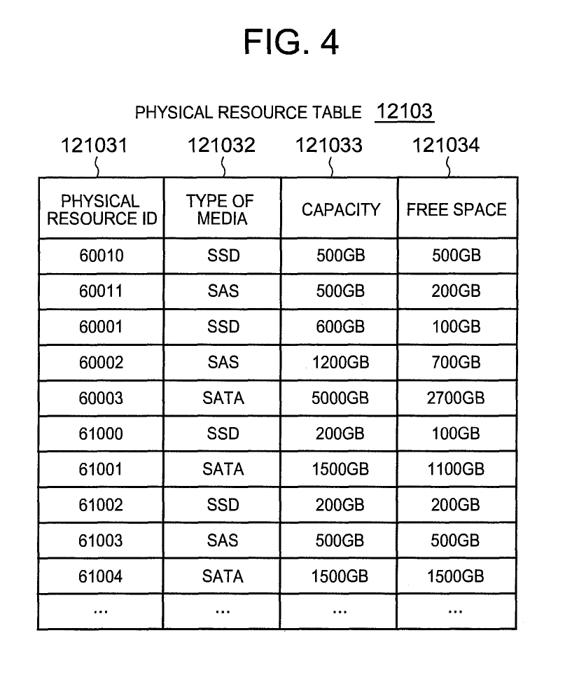

The physical resource table 12103 is for storing information related to all the physical resources 11201 of the storage subsystem 10000. FIG. 4 shows a specific example. The physical resource table 12103 comprises the following information for each physical resource 11201.

(*) A physical resource ID 121031, which is the identifier of the physical resource 11201,
(*) a media type 121032, which is information denoting the type of physical resource 11201 media,
(*) a capacity 121033, which is information showing the capacity of the physical resource 11201, and
(*) a free space 121034, which is information showing the free space of the physical resource 11201.

The “free space” of the physical resource 11201 is the capacity of the storage space, from among the storage spaces of the physical resource 11201, which is not being used as either a real volume 11100 (1) or a segment.

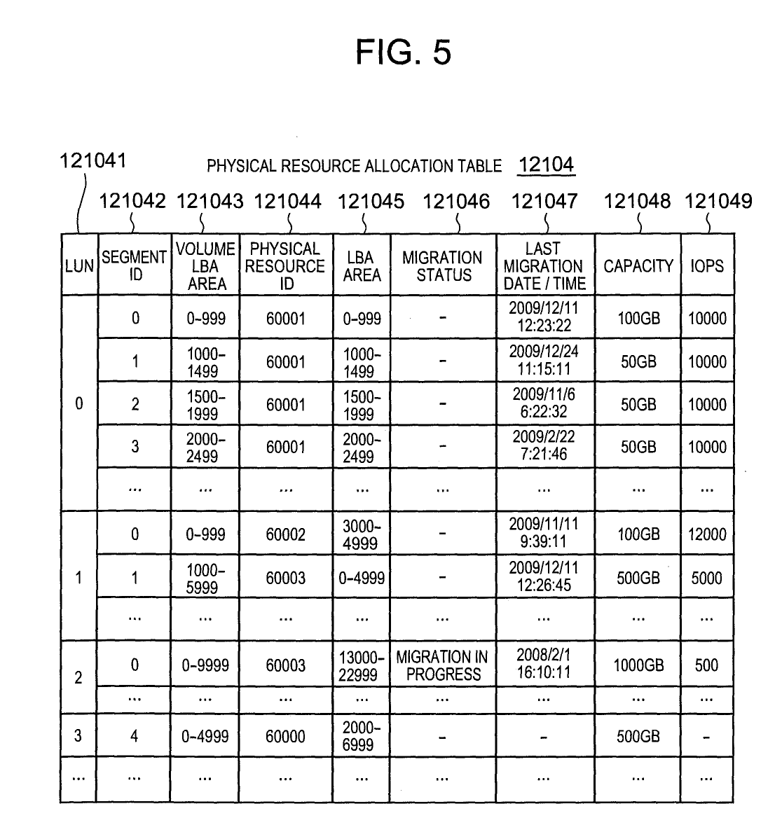

The physical resource allocation table 12104 is for storing information related to the allocation of physical resources to all the logical volumes 11100 of the storage subsystem 10000. FIG. 5 shows a specific example. The physical resource allocation table 12104 comprises the following information for each storage area (hereinafter, volume area) configuring the logical volume 11100. Furthermore, the volume area is either all or a part of the real volume 11100 (1) in a case where the logical volume 11100 is the real volume 11100 (1), and is one virtual region in the virtual volume 11100 (2) in a case where the logical volume 11100 is the virtual volume 11100 (2).

(*) A LUN 121041, which is the identifier for identifying the logical volume 11100 that comprises the volume area,
(*) an area ID 121042, which is the identifier for identifying the volume area,
(*) a volume LBA 121043, which is the LBA (Logical Block Address) showing the location of the volume area in the logical volume 11100,
(*) a physical resource ID 121044, which is the identifier for indentifying the physical resource 11201 that comprises the physical storage area allocated to the volume area,
(*) a physical LBA 121045, which is the LBA showing the location in either the pool 11200 or the physical resource 11201 of the physical storage areas allocated to the volume area,
(*) a migration status 121046, which is information showing the status related to a data migration,
(*) a last migration date/time 121047, which is information showing the last time a data migration was performed,
(*) a capacity 121048, which is information showing the capacity of the physical storage area allocated to the volume area, and
(*) a IOPS 121049, which is information showing the virtual area I/O frequency.

Information other than the LBA may be used as at least one of the volume area and physical storage area location information.

The physical storage area is a storage area of the physical resource 11201 that does not configure a pool 11200 in a case where the allocation-destination volume is either all or a part of the real volume 11100 (1), and is a segment in a case where the allocation-destination volume is a virtual area. By combining the physical resource ID 121044 and the physical LBA 121045 of this table 12104, it is possible to identify which segments of which physical resource 11201 are being used (allocated), and which segments are unused (unallocated). Furthermore, aside from the table 12104, for example, segment information for managing the used/unused status for each segment may be prepared.

There are two types of values for the migration status 121046, for example, a hyphen (-) and “migration in progress”. As used here, the hyphen signifies a state in which a migration is not being performed, and “migration in progress” signifies that data inside the volume area is in the process of being migrated. However, the value of the migration status 121046 is not limited to these two types.

There are two types of values for the last migration data/time 121047, for example, a hyphen (-) and a time. The hyphen signifies that a data migration has not been performed, and the time is the time at which a data migration was recently performed. However, the last migration date/time 121047 is information used for identifying a virtual volume 11100 (2) for which a dynamic reallocation is regarded as being ineffective, and another type of information besides the last migration date/time 121047 may be used as information that makes it possible to identify a virtual volume 11100 (2) for which a dynamic reallocation is regarded as being ineffective.

As the dynamic reallocation condition, the I/O frequency range (IOPS range) may be used, and the I/O frequency (IOPS) of each virtual area is monitored, but instead of the I/O frequency, the target for monitoring each virtual area may be another type of I/O load, such as the data transmission rate, or may be another type of attribute value, such as the last I/O date/time.

According to FIG. 5, when there is a virtual volume 11100 (2) that is configured from a plurality of virtual areas of the same size, there may also be a virtual volume 11100 (2) in which a plurality of virtual areas of different sizes are mixed together. Further, when there is a pool 11200 that is configured from a plurality of segments of the same size, there may also be a pool 11200 in which segments of different sizes are mixed together. Also, one segment is allocated to one virtual area, but one segment may be allocated to a plurality of virtual areas, and a plurality of segments may be allocated to one virtual area.

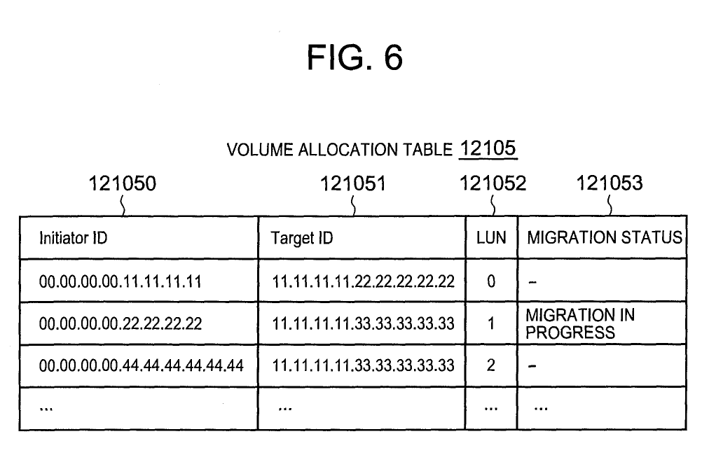

Refer to FIG. 1 once again. The volume allocation table 12105 is for storing information related to a logical volume 11100 that is allocated to the host computer 20000. FIG. 6 shows a specific example. The volume allocation table 12105 comprises the following information for each logical volume 11100 provided to the host computer 20000.

(*) An Initiator ID 121050, which is the identifier for identifying the I/F 23000 of the host computer 20000,
(*) a Target ID 121051, which is the identifier for identifying the I/F (A) 12300 of the storage subsystem 10000,
(*) a LUN 121052, which is the identifier for identifying a logical volume 11100, and
(*) a migration status 121053, which is information showing a status related to a data migration with respect to a logical volume 11100.

A WWN (World Wide Name) is one example of the value of the Initiator ID 121050 and the value of the Target ID 121051, but these values are not limited to a WWN, and another type of identification information may be used.

The configuration information acquisition program 12106 is for collecting the configuration information of the storage subsystem 10000, and sending this information to another program. As the configuration information, for example, information about the logical volume 11100 (the LUN or free space), and information denoting whether or not a path has been established to the logical volume 11100 may be cited, but the configuration information is not limited to this information, and as long as it is information that is required by the management computer 40000, other information may be used.

The volume copy program 12107 is for copying data inside a logical volume 11100 to another logical volume 11100. In explaining this example, the copying of data from a certain logical volume 11100 to another logical volume 11100 will be called a “volume copy”.

The volume migration program 12108 is for migrating data inside a logical volume 11100 to another logical volume 11100. In explaining this example, the migration of data from a certain logical volume 11100 to another logical volume 11100 will be called a “volume migration”. In a volume migration, data is copied from a migration-source logical volume 11100 to a migration-destination logical volume 11100, and the LUN (hereinafter, the target LUN) of the migration-source logical volume 11100 is associated with the migration-destination logical volume 11100 instead of the migration-source logical volume 11100. Thereafter, upon receiving an I/O request specifying the target LUN from the host computer 20000, the controller 12000 carries out the I/O with respect to the migration-destination logical volume 11100 defined on the basis of the target LUN specified in this I/O request. The data inside the migration-source logical volume 11100 may be deleted. The controller 12000 may perform the following processing in a case where an I/O request specifying the target LUN is received from the host computer 20000 during a volume migration (prior to the target LUN being associated with the migration-destination logical volume). That is, in a case where this I/O request is a read request, the controller 12000 may read the read-targeted data from the migration-source logical volume. In a case where this I/O request is a write request, the controller 12000 may store the write-targeted data in a cache memory area (for example, an area inside the memory 12100), and thereafter, may write the write-targeted data to the migration-destination logical volume 11100.

The I/O control program 12109 is for controlling an I/O to a logical volume 11100 from the host computer 20000.

The segment copy program 12110 is for copying data from a certain segment to another segment. In explaining this example, the copying of data from a certain segment to another segment will be called a “segment copy”.

The segment migration program 12111 is for migrating the data inside a certain segment to another segment. In explaining this example, the migration of data from a certain segment to another segment will be called a “segment migration”.

The segment migration instruction program 12112 is for instructing the segment migration program 12111 to perform a segment migration in a case where a segment (a migration-source segment) that satisfies the dynamic reallocation condition is detected.

The processor 12200 controls the execution of a program inside the memory 12100 and the input/output of data to/from the memory 12100, and the input/output of data and control commands via the I/Fs 12300 and 12400 of the controller 12000.

The storage subsystem 10000 also comprises ordinary functions, such as a function for creating a pool 11200, a function for creating a logical volume 11100, a function for providing a logical volume 11100 to the host computer 20000 by way of the I/F (A) 12300, and a function for receiving a configuration change request with respect to the storage subsystem 10000 from the management computer 40000.

The storage subsystem 10000 may also comprise an input device for the user of the storage subsystem 10000 to input data, and an output device for providing information to the user of the storage subsystem 10000.

The host computer 20000 comprises a memory 21000, a processor 22000, and an I/F 23000. These elements, for example, are coupled via a bus. The I/F 23000 is for communicating using a first protocol (for example, a FC (Fibre Channel) protocol), and is coupled to the I/F (A) 12300 of the storage subsystem 10000 via the switch 30000. The memory 21000 stores programs and data utilized by the processor 22000. In particular, the memory 21000 comprises an application 21001. Another type of physical storage resource may be used either instead of or in addition to the memory 21000. The application 21001 may be any type of program. The processor 22000 controls the execution of a program inside the memory 21000 and the input/output of data to/from the memory 21000, and the input/output of data and control commands via the I/F 23000.

The host computer 20000 may also comprise an input device for the user of the host computer 20000 to input data, and an output device for providing information to the user of the host computer 20000.

The switch 30000 comprises an I/F (A) 31000, which is coupled to the storage subsystem 10000, and an I/F (A) 32000, which is coupled to the host computer 20000. The network protocol (the above-mentioned first communication protocol) that is used between the storage subsystem 10000, the host computer 20000, and the switch 30000, which is coupled to both, is the FC (Fibre Channel) or the iSCSI (Internet Small Computer System Interface), but another type of protocol man be used instead of these. Further, the number of I/Fs (A) is not limited to two, and may be equal to or greater than three.

The switch 50000 comprises an I/F (B) 51000, which is coupled to the storage subsystem 10000, and an I/F (B) 52000, which is coupled to the management computer 40000.

Further, the number of I/Fs (B) is not limited to two, and may be equal to or greater than three.

The management computer 40000 comprises a memory 41000, an I/F 43000, and a processor 42000, which is coupled to this memory 41000 and I/F 43000. The memory 41000 stores programs and data that are used by the processor 42000. In particular, the memory 41000 comprises a configuration information table 41001, a policy table 41002, a configuration management program 41003, a policy decision program 41004, a migration instruction program 41005, and a migration-destination determination program 41006. Another type of physical storage resource may be used either instead of or in addition to the memory 41000.

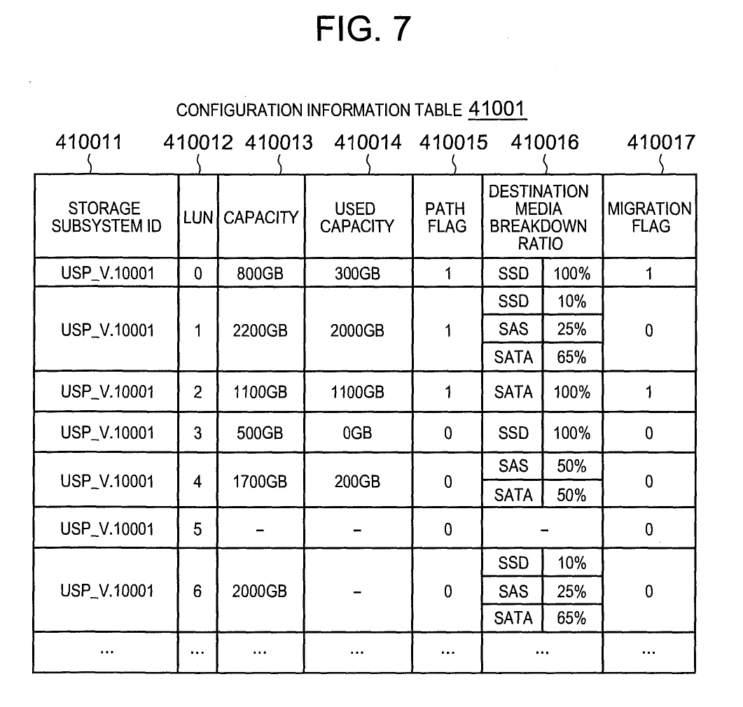

The configuration information table 41001 holds the configuration information of the storage subsystem 10000. FIG. 7 shows a specific example. The configuration information table 41001 comprises the following information for each logical volume 11100.

(*) a storage subsystem ID 410011, which is the identifier for identifying the storage subsystem 10000 that comprises the logical volume 11100,
(*) a LUN 410012, which is the identifier for indentifying the logical volume 11100,
(*) a capacity 410013, which is information showing the capacity of the logical volume 11100,
(*) a used capacity 410014, which is information showing the used capacity of the logical volume 11100,
(*) a path flag 410015, which denotes whether or not the logical volume 11100 has been allocated to the host computer 20000,
(*) a destination media breakdown 410016, which is information showing what percentage of the physical storage areas by type of media exists for all of the physical storage areas allocated to the logical volume 11100, and
(*) a migration flag 410017, which denotes whether or not the logical volume 11100 is a migration target (whether or not it is a migration source).

When the path flag 410015 is ON (1), an I/O may be carried out from the host computer 20000 to the logical volume 11100. Specifically, for example, in the path flag 410015 denotes that the logical volume 11100 and the host computer 20000 are linked via a logical path, or that this logical path is valid. Alternatively, when the path flag 410015 is OFF (0), an I/O may not be carried out from the host computer 20000 to the logical volume 11100. Specifically, for example, in the path flag 410015 denotes that the logical volume 11100 and the host computer 20000 are not linked via a logical path, or that this logical path is invalid. As will be explained hereinbelow, a condition of the migration-destination real volume 11100 (1) may be that the path flag 410015 be OFF (0). After determining the real volume 11100 (1) for which the path flag 410015 is OFF (0) as the migration destination, and carrying out a volume migration, which will be described hereinbelow, the path flag 410015 for this migration-destination real volume 11100 (1) is turned ON (1) by the processor 42000 of the management computer 40000. Further, a logical path is established (or an already existing logical path is switched from invalid to valid) between the migration-destination real volume 11100 (1) and the host computer 20000.

When the migration flag 410017 is ON (1), the logical volume 11100 is the migration target, and when the migration flag 410017 is OFF (0), the logical volume 11100 is not the migration target.

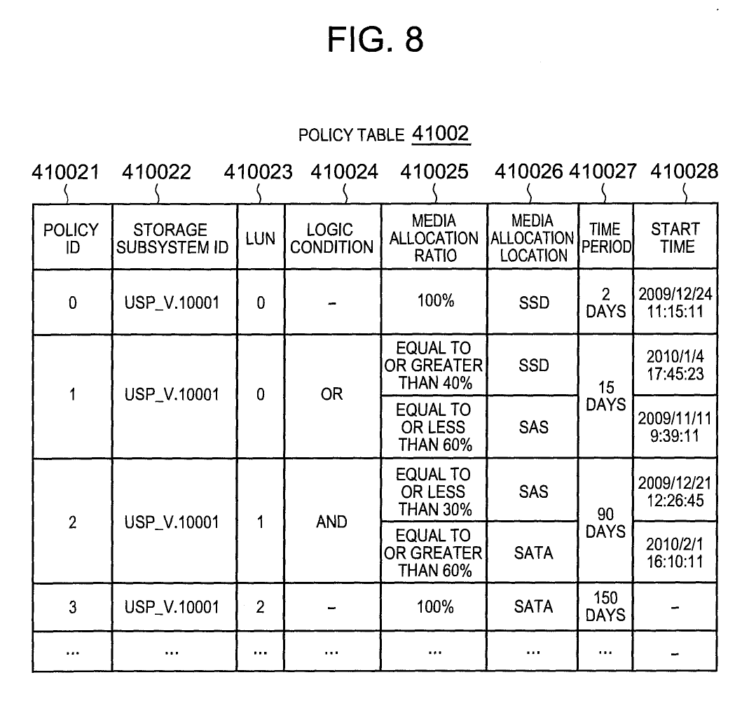

The policy table 41002 comprises information related to the condition (that is, the migration policy) with respect to the virtual volume 11100 (2) for which a dynamic reallocation is considered to be ineffective. The migration policy, in other words, defines the trigger that starts a volume migration from the virtual volume 11100 (2) to the real volume 11100 (1). FIG. 8 shows a specific example. According to FIG. 8, the policy table 41002 comprises the following information for each migration policy. Furthermore, in the following explanation, a segment based on a SSD may be called a “SSD segment”, a segment based on a SAS-HDD may be called a “SAS segment”, and a segment based on a SATA-HDD may be called a “SATA segment”.

(*) a policy ID 410021, which is the identifier for identifying the migration policy,
(*) a storage subsystem ID 410022, which is the identifier for indentifying the storage subsystem 10000,
(*) a LUN 410023, which is the identifier for identifying the virtual volume 11100 (2),
(*) a logic condition 410024, which is information showing the logic condition,
(*) a media allocation ratio 410025, which is information showing the condition with respect to the media allocation ratio,
(*) a media allocation location 410026, which is information showing the condition with respect to the media allocation location,
(*) a time period 410027, which is information showing the condition with respect to the period of time (the elapsed time from the time denoted by the start time 410028) during which both the media allocation ratio condition and the media allocation location condition have continuously been satisfied, and
(*) a start time 410028, which is information showing the time at which it was detected that both the media allocation ratio condition and the media allocation location condition were satisfied.

The “logic condition” is a condition related to a combination of a plurality of condition sets for one virtual volume 11100 (2). The migration policy is defined by a combination of a condition set and the logic condition 410024. The conditions configuring the migration policy need not be limited to the above-mentioned example.

The values of the logic condition 410024 are AND and OR. For example, in a case where two condition sets are defined and the logic condition is AND, the migration policy is satisfied when the two condition sets are both satisfied, and in a case where the logic condition is OR, the migration policy is satisfied when one of the two condition sets is satisfied.

The “condition set” is a combination of the condition shown for the media allocation ratio 410025, the condition shown for the media allocation location 410026, and the condition shown for the time period 410027.

The “media allocation ratio” denotes the extent to which segments of a certain media type exist among all the segments (that is, the used capacity) allocated to the virtual volume 11100 (2).

The “media allocation location” is the media type of the physical storage device that is serving as the basis of the segment allocated to the virtual volume 11100 (2).

The decision as to whether or not a migration policy has been satisfied will be explained below based on this table 41002. In the following explanation, the focus will be on policy ID “3”. The virtual volume 11100 (2) of the LUN “2” will be expressed as “VVOL #2”.

(*) For example, it is supposed that five of the 10 segments allocated to the VVOL #2 are SATA segments. In accordance with this, the SATA media allocation ratio is 50%. Therefore, at this stage, the condition that states that the media allocation ratio 410025 shows “100%” has not been satisfied (that is, the migration policy has not been satisfied).
(*) It is supposed that thereafter all the segments allocated to the VVOL #2 become SATA segments as the result of a dynamic reallocation. The value that denotes the time (hereinafter, the detection time) at which this state was detected is registered in the table 41002 as the start time 410028 corresponding to the policy ID “3”.
(*) It is supposed that thereafter the SATA media allocation ratio for the VVOL #2 becomes less than 100% as the result of a dynamic reallocation before 150 days (the time period corresponding to the policy ID “3”) has elapsed since the time shown in the start time 410028. In accordance with this, the time (value) shown in the start time 410028 corresponding to the policy ID “3” is reset.
(*) Alternatively, in a case where it is detected that 150 days (the time period corresponding to the policy ID “3”) has elapsed since the time shown in the start time 410028 without the SATA media allocation ratio becoming less than 100% (that is, a case where the prescribed time period has elapsed with both the media allocation ratio condition and the media allocation location condition continuing to be satisfied), the migration policy corresponding to the policy ID “3” has been satisfied. In this case, the volume migration is carried out from the VVOL #2 to the real volume 11100 (1).

The configuration management program 41003 is for managing the configuration of the storage subsystem 10000. The configuration management program 41003 acquires the configuration information of the storage subsystem 10000 by communicating with the configuration information acquisition program 12106 in the storage subsystem 10000. The configuration management program 41003 may comprise at least one of a function for creating a pool 11200, a function for creating a logical volume 11100, a function for allocating a logical volume 11100 to the host computer 20000, and a scheduler function for performing a specified process at a specified time. In this example, the configuration management program 41003 provides a migration setting UI (User Interface). The user (the storage administrator) is able to set a migration policy using this UI. However, the method for performing a migration policy-related setting is not limited to using the UI, and another method may be used.

The policy decision program 41004 discovers a virtual volume 11100 (2) that satisfies the migration policy. The policy decision program 41004, upon discovering the virtual volume 11100 (2) that satisfies the migration policy, turns ON (1) the migration flag (the flag in the configuration information table 41001) 410018 corresponding to this virtual volume 11100 (2). The virtual volume 11100 (2) corresponding to the record (the row) in which the migration flag 410018 is ON (1) is the migration-targeted virtual volume 11100 (2).

The migration instruction program 41005 decides whether or not a migration-targeted virtual volume 11100 (2) exists, implements the migration-destination determination program 41006 in a case where this volume 11100 (2) exists, and instructs the volume migration program 12108 to carry out a volume migration.

The migration-destination determination program 41006 determines the migration-destination logical volume 11100.

The processing carried out via this example will be explained below.

### <Overview of Write Process With Respect to Virtual Volume 11100 (2)>

This processing is as follows.

(a1) The I/O control program 12109 receives a write request from the host computer 20000.
(a2) The program 12109 identifies the write-destination virtual volume 11100 (2) and the write-destination virtual area based on the I/O destination information of the write request. The I/O destination information denotes the I/O destination, and, for example, comprises the LUN of the virtual volume 11100 (2) and the LBA of the virtual area.
(a3) The program 12109 stores write-targeted data that accords with the write request in the cache memory area. The program 12109 may respond with write-complete to the host computer 20000 at this stage.
(a4) The program 12109 determines whether a segment has been allocated to the write-destination virtual area identified in the above-mentioned (a2) based on the physical resource allocation table 12104.
(a5) In a case where the result of the determination in the above-mentioned (a4) is affirmative, the program 12109 writes the write-targeted data in the cache memory area to the segment allocated to the write-destination virtual area.
(a6) In a case where the result of the determination in the above-mentioned (a4) is negative, the program 12109 identifies an unused segment (a segment that is not allocated to any virtual area) based on the physical resource allocation table 12104. The program 12109 may identify an unused segment from a segment group with the highest possible performance at this time.
(a7) The program 12109 associates the segment identified in the above-mentioned (a6) to the write-destination virtual area. Specifically, for example, the program 12109 registers the ID of the physical resource 12101 that constitutes the basis of the allocated segment and the LBA of this segment in the physical resource allocation table 12104 as the information 121044 and 121045 corresponding to the write-destination virtual area.
(a8) The program 12109 writes the write-targeted data in the cache memory area to the segment identified in the above-mentioned (a6) (The program 12109 may respond with write-complete to the host computer 20000 at this stage.).
(a9) The program 12109 updates the IOPS 121049 corresponding to the write-destination virtual area in any of the above-mentioned (a2) through (a8).
<Overview of Read Process with Respect to Virtual Volume 11100 (2)>

This processing is as follows.

(b1) The I/O control program 12109 receives a read request from the host computer 20000.
(b2) The program 12109 identifies the read-source virtual volume 11100 (2) and the read-source virtual area based on the I/O destination information in the read request.
(b3) The program 12109 determines whether or not the read-targeted data resides in the cache memory area.
(b4) In a case where the result of the determination in the above-mentioned (b3) is affirmative, the program 12109 sends the read-targeted data inside the cache memory area to the host computer 20000. The IOPS 121049 corresponding to the read-source virtual area may or may not be updated in accordance with this.
(b5) In a case where the result of the determination in the above-mentioned (b3) is negative, the program 12109 determines whether a segment is allocated to the read-source virtual area identified in the above-mentioned (b2) based on the physical resource allocation table 12104.
(b6) In a case where the result of the determination in the above-mentioned (b5) is negative, the program 12109 sends prescribed data (for example, an error) to the host computer 20000.
(b7) In a case where the result of the determination in the above-mentioned (b5) is affirmative, the program 12109 reads the data from the segment allocated to the read-source virtual area, and writes this data to the cache memory area. Then, the program 12109 sends this data inside the cache memory area to the host computer 20000.
(b8) The program 12109 updates the IOPS 121049 corresponding to the read-source virtual area in any of the above-mentioned (b2) through (b7).

### <Overview of Dynamic Reallocation>

This processing is as follows. Dynamic reallocation, for example, is performed either regularly or irregularly.

(c1) The segment migration instruction program 12112 determines whether or not a migration-source segment exists. The “migration-source segment” is a segment that does not belong to the I/O frequency (IOPS) within the I/O frequency range shown in the relevant dynamic allocation condition 121025.
(c2) In a case where the result of the determination in the above-mentioned (c1) is affirmative, the program 12112 instructs the segment migration program 12111 to perform a segment migration.
(c3) The segment migration program 12111 updates the migration status 121046 (the information 121046 in the table 12104) corresponding to the virtual area to which the migration-source segment is allocated to “migration in progress”.
(c4) The program 12111 determines the segment inside the segment group (the physical resource 11201) corresponding to the I/O frequency range of the I/O frequency that corresponds to the migration-source segment as the migration destination.
(c5) The program 12111 migrates the data from the migration-source segment to the migration-destination segment.
(c6) The program 12111 allocates the migration-destination segment to the virtual area to which the migration-source segment has been allocated instead of the migration-source segment.
(c7) The program 12111 updates to a hyphen (-) the migration status 121046 corresponding to the virtual area to which the migration-destination segment was allocated.

### <Migration Police Setting Process>

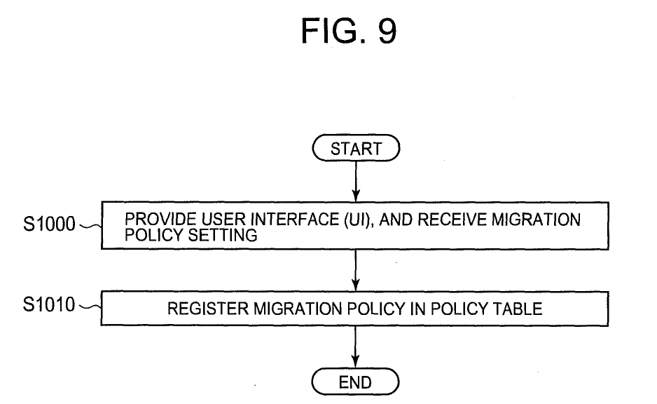

FIG. 9 shows the sequence of a migration policy setting process.

In Step S1000 of this process, first the user (the storage administrator) sets the migration policy of the logical volume 11100 comprising the dynamic reallocation function via the UI provided by the configuration management program 41003.

Next, in Step S1010, the configuration management program 41003 writes the information that was received in Step S1000 to the policy table 41002.

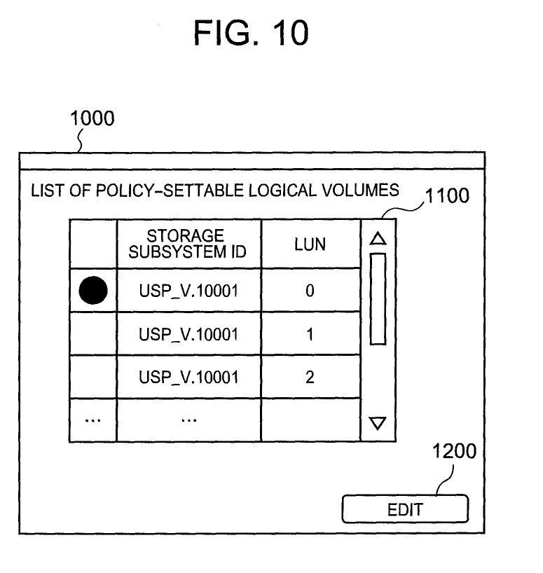

FIG. 10 shows a first UI 1000 displayed in Step S1000 of FIG. 9.

The first UI 1000 is for selecting the virtual volume 11100 (2) to be associated with the migration policy. The first UI 1000 is provided by the configuration management program 41003. The first UI 1000 comprises a table 1100, which displays a list of virtual volumes 11100 (2) for which dynamic reallocation has been performed, and a button 1200 for editing the migration setting of the virtual volume 11100 (2). It is supposed that the logical volume list table 1100 comprises checkboxes, and that the user is able to select each row.

The user selects a logical volume 11100 for which a policy is to be edited from the table 1100, and presses the button 1200. After the user presses the button 1200, a second UI is displayed.

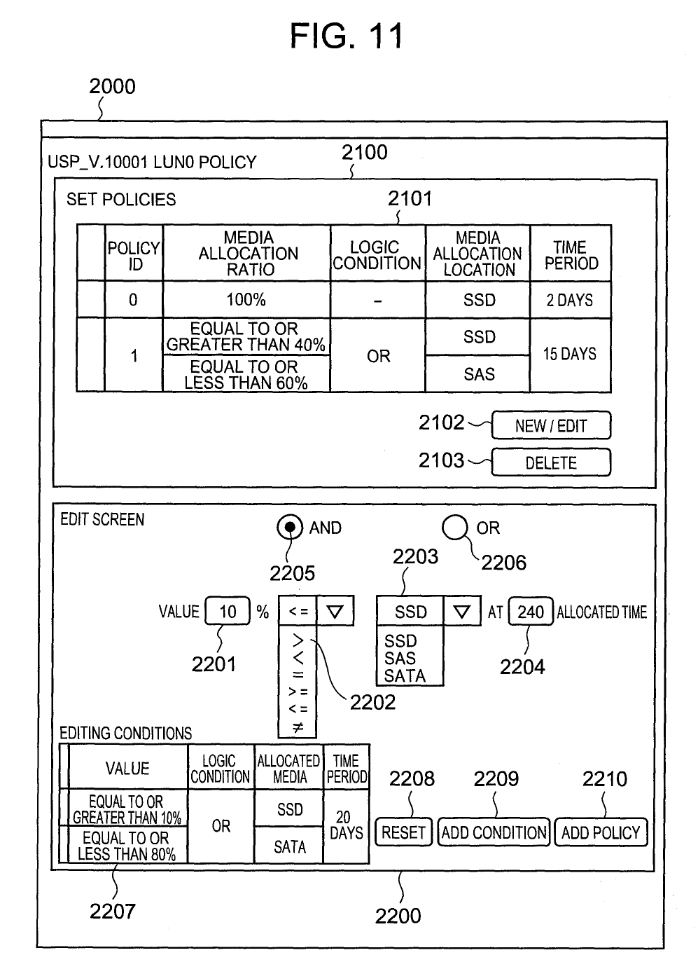

FIG. 11 shows a second UI 2000.

The second UI 2000 is used to set the details of the policy of the virtual volume (hereinafter, referred to as the “selected volume” in the explanation of FIG. 11) 11100 (2) that was selected from the first UI 1000 of FIG. 10. The second UI 2000 is provided by the configuration management program 41003. The second UI 2000 comprises an area 2100, which displays the migration policy selected with respect to the selected volume 11100 (2), and an area 2200 in which is displayed a tool (a text box, drop-down box or the like) that is used in editing the migration policy of the logical volume 11100.

The area 2100 comprises a table 2101, which displays the set migration policy with respect to the selected volume 11100 (2), a button 2102 for specifying the editing of the migration policy set with respect to the selected volume 11100 (2), and a button 2103 for specifying the deletion of the set migration policy. The table 2101 comprises checkboxes, and the user is able to select a desired migration policy by selecting the row in which the desired migration policy is being displayed.

The area 2200 comprises a text box 2201 into which a media allocation ratio 410025 value is inputted, a drop-down box 2202 via which relational operators are specified, a drop-down box 2203 into which a media allocation location 410026 value is inputted, a text box 2204 into which a time period 410027 value is inputted, radio buttons 2205 and 2206 for specifying a logic condition 410024 value, a table 2207 in which is displayed a migration policy that is in the process of being edited, a button 2208 for specifying the resetting of a migration policy that is being edited, a button 2209 for specifying the addition of either a condition set or a logic condition to a migration policy that is being edited, and a button 2210 for specifying the addition to the policy table 41002 of a migration policy for which editing has been completed.

The user specifies via the area 2100 that a migration policy which has been set with respect to the selected volume 11100 (2), is to be newly set, edited or deleted.

In a case where a migration policy has been newly added, the user sets the migration policy via the area 2200.

In a case where the set migration policy is to be edited, the user selects the migration policy that has been set with respect to the selected volume 11100 (2) using the checkbox. When editing this policy, the user presses the button 2102. In a case where the button 2102 has been pressed, the configuration management program 41003 displays this set policy in the table 2207.

In a case where a set migration policy is to be deleted, the user presses the button 2103. When the button 2203 has been pressed, the configuration management program 41003 deletes the set migration policy from the table 2101.

The user is able to either set a new migration policy or edit an existing migration policy using the area 2200. The user is able to use the tools 2201 and 2202 to specify the value of the media allocation ratio 410025. In a case where a condition set is to be added to the migration policy, the user selects either one of the radio buttons 2205 and 2206, and presses the button 2209. When the button 2209 is pressed, the configuration management program 41003 displays the condition set that is being edited in the table 2207. In a case where the condition setting has been completed and the migration policy has been added with respect to the selected volume 11100 (2), the user presses the button 2210. When the button 2210 is pressed, the configuration management program 41003 adds the inputted migration policy to the policy table 41002, and updates the list of migration policies in the table 2101.

In a case where the migration policy that is being edited is to be reset, the user presses the button 2208. When the button 2208 is pressed, the configuration management program 41003 deletes the information that is being displayed in the table 2207.

In accordance with the above-described setting method, the user is able to decide the details of the migration policy that is set with respect to the selected volume 11100 (2). Furthermore, the migration policy entry does not have to be expressed as in the drawing, but rather a UI that is able to describe the condition for identifying by a user (a storage administrator) a logical volume 11100 for which dynamic reallocation is ineffective may be used. In this example, the user utilizes the UI 2000 and the UI 2100 to determine the policy for identifying a logical volume 11100 for which dynamic reallocation is ineffective, but this method does not have to be used. For example, the condition for identifying a logical volume 11100 for which dynamic reallocation is ineffective may be described beforehand in the management computer 41000.

### <Configuration Information Acquisition Process>

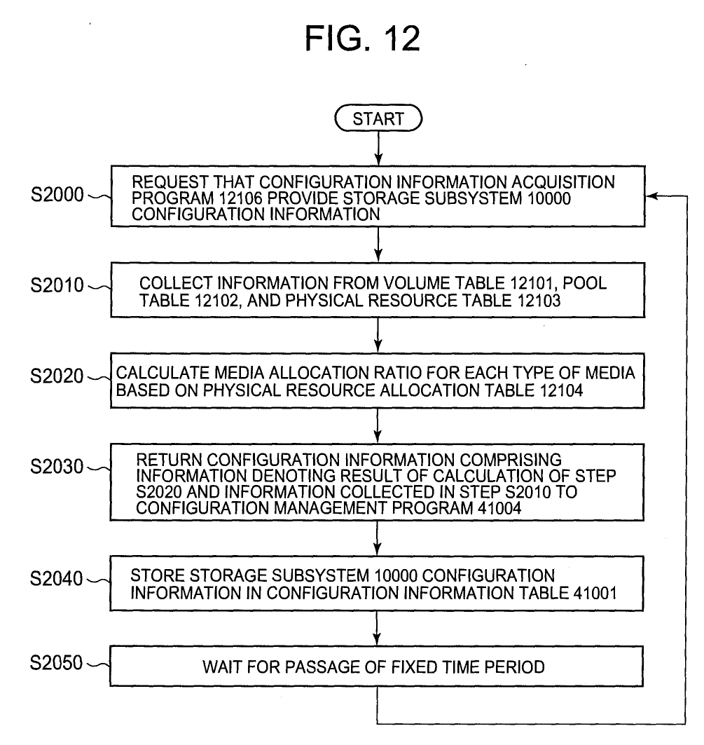

FIG. 12 shows the sequence of the configuration information acquisition process. In this example, the configuration information acquisition program 12106 may be executed in parallel with another program of the management computer 40000.

In Step S2000 of this process, first the configuration management program 41003 requests that the configuration information acquisition program 12106 provide the configuration information of the storage subsystem 10000.

In Step S2010, the configuration information acquisition program 12106 collects the configuration information of the storage subsystem 10000 from the volume table 12101, the pool table 12102, and the physical resource table 12103.

In Step S2020, the configuration information acquisition program 12106, based on the physical resource table 12103 and the physical resource allocation table 12104, calculates the media allocation ratio for each media type with respect to the virtual volume 11100 (2). Specifically, for example, the following is performed.

(*) The program 12106 references the physical resource table 12103 and the physical resource allocation table 12104.
(*) The program 12106 identifies the media type 121032 corresponding to the physical resource ID 121044 that corresponds to the virtual area (the segment that has been allocated to the virtual area) of the virtual volume 11100 (2).
(*) The program 12106 calculates the media allocation ratio for each media type with respect to this virtual volume 11100 (2) based on the capacity 121014 corresponding to the virtual volume 11100 (2), and the capacity 121048 and above-mentioned identified media type 121032 with respect to the segment-allocated virtual area in this virtual volume 11100 (2).

In Step S2030, the program 12106 returns to the configuration management program 41003 the configuration information, which comprises the information collected in Step S2010 and the media allocation ratio of each media type (information equivalent to the allocation-destination media breakdown 410016) calculated in Step S2020.

In Step S2040, the configuration management program 41003 stores the configuration information from the storage subsystem 10000 in the configuration information table 41001.

In Step S2050, the configuration management program 41003 waits for a fixed period of time. Thereafter, Step S2000 is carried out once again. The length of time that the configuration management program 41003 waits in this Step may be stipulated beforehand, and may be changed on a timely basis by the user.

### <Determination and Identification of Migration Target>

In the process of determining a migration target, a virtual volume 11100 (2) for which a dynamic reallocation is considered ineffective, that is, a migration-target virtual volume 11100 (2), is determined.

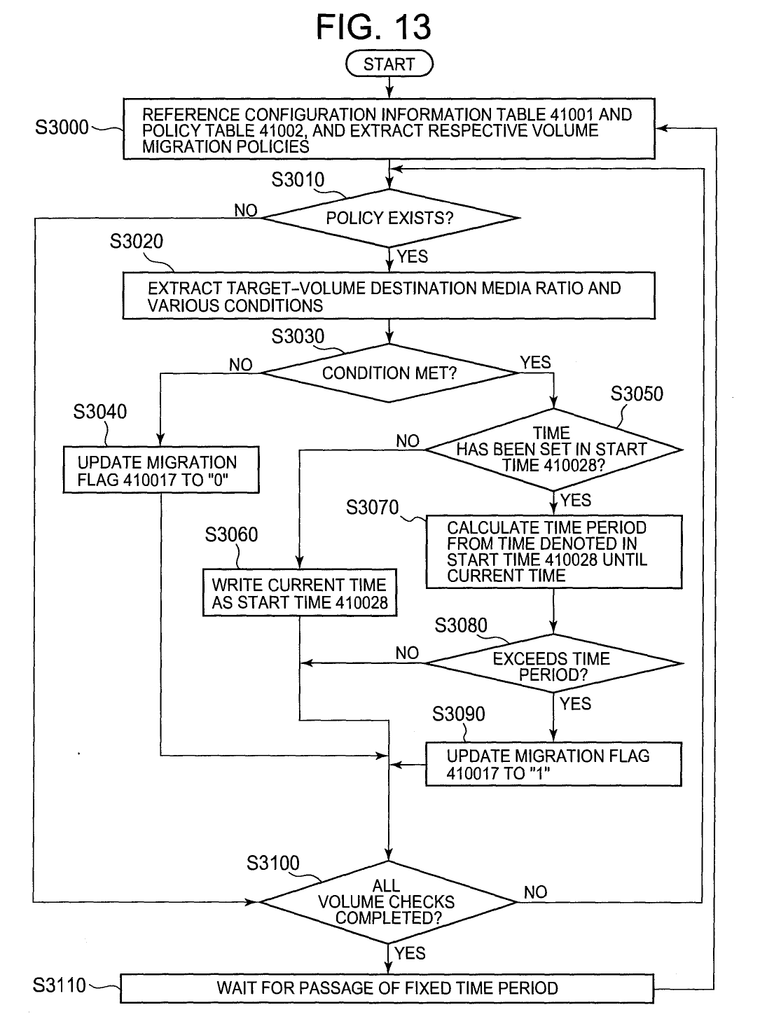

FIG. 13 shows the sequence of a migration target determination process. In this example, the policy decision program 41004 may be executed in parallel with another program of the management computer 40000.

In Step S3000 of this process, first the policy decision program 41004 references the configuration information table 41001 and the policy table 41002, and extracts the migration policies from the table 41002.

In Step S3010, the program 41004 determines whether or not any of the migration policies extracted in Step S3000 are set with respect to one virtual volume (referred to as the “target volume” in the explanation of FIG. 13) 11100 (2) identified from the configuration information table 41001. In a case where the result of this determination is negative, Step S3100 is carried out, and in a case where the result of this determination is affirmative, Step S3020 is carried out. In the explanation of FIG. 13, the migration policy for which the result of the determination in Step S3010 was affirmative is referred to as the “target policy”.

In Step S3020, the program 41004 references the configuration information table 41001 and the policy table 41002 and extracts one or more media allocation ratios shown in the allocation-destination media breakdown 410016 corresponding to the target volume 11100 (2), and the conditions respectively shown in the logic condition 410024, the media allocation ratio 410025 and the media allocation location 410026 corresponding to the target policy.

In Step S3030, the program 41004 determines whether or not the one or more media allocation ratios shown in the allocation-destination media breakdown 410016 conform to the conditions shown in the information 410024 through 410026 corresponding to the target policy. In a case where the result of this determination is negative, Step S3040 is carried out, and in a case where the result of this determination is affirmative, Step S3050 is carried out.

In Step S3040, the program 41004 turns OFF (0) the migration flag 410017 corresponding to the target volume 11100 (2).

In Step S3050, the program 41004 determines whether a valid value (time) is set as the start time 410028 corresponding to the target policy. In a case where the result of this determination is negative, Step S3060 is carried out, and in a where the result of this determination is affirmative, Step S3070 is carried out.

In Step S3060, the program 41004 registers the information showing the current time as the start time 410028 corresponding to the target policy.

In Step S3070, the program 41004 calculates the time period from the start time 410028 corresponding to the target policy until the current time.

In Step S3080, the program 41004 determines whether or not the calculated time period exceeds the time period shown in the time period 410027 corresponding to the target policy. In a case where the result of this determination is negative, Step S3100 is carried out, and in a case where the result of this determination is affirmative, Step S3090 is carried out.

In Step S3090, the program 41004 turns ON (1) the migration flag 410017 corresponding to the target volume 11100 (2).

In Step S3100, the program 41004 determines whether or not all the logical volumes 11100 have been checked. In a case where the result of this determination is negative, Step S3010 is carried out once again, and in a case where the result of this determination is affirmative, Step S3110 is carried out.

In Step S3110, the program 41004 waits for a fixed period of time. Thereafter, Step S3000 is carried out once again. Furthermore, the period of time which the policy decision program 41004 waits in this Step may be determined beforehand, or may be changed on a timely basis by the user.

### <Migration Instruction Process>

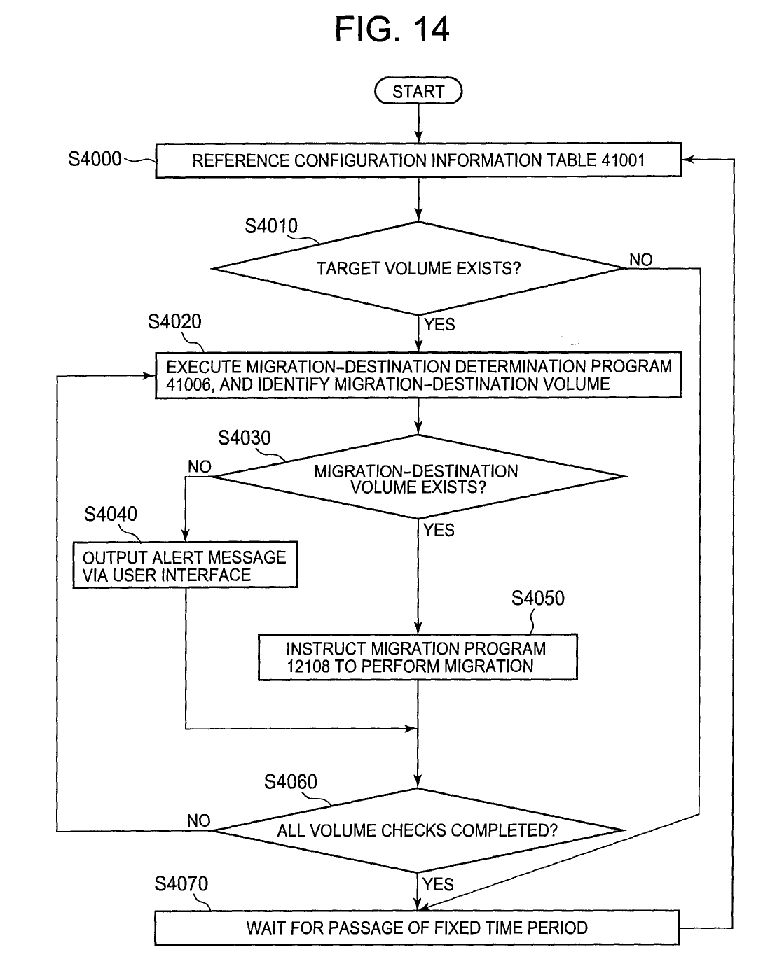

FIG. 14 shows the sequence of a migration instruction process.

In Step S4000 of this process, first the migration instruction program 41005 references the configuration information table 41001.

In Step S4010, the program 41005 determines whether or not a virtual volume 11100 (2) for which the migration flag 410017 is ON (1) (that is, a migration-targeted virtual volume 11100 (2)) exists. In a case where the result of this determination is negative, Step S4070 is carried out, and in a case where the result of this determination is affirmative, Step S4020 is carried out.

In Step S4020, the program 41005 executes the migration destination determination program 41006 and obtains information on the migration-destination real volume 11100 (1). As used here, real volume 11100 (1) information, for example, is information comprising the storage subsystem ID and the LUN. In a case where a migration-destination real volume 11100 (1) does not exist, the migration instruction program 41005 obtains information (hereinafter, referred to a “NULL”) showing that a migration-destination real volume 11100 (1) does not exist. However, the information that the migration instruction program 41005 obtains in this Step is not limited to this, but rather may be information that makes it possible to distinguish whether or not a migration-destination real volume 11100 (1) exists. The processing sequence carried out by the migration destination determination program 41006 will be described hereinbelow.

In Step S4030, the program 41005 determines whether or not a migration-destination real volume 11100 (1) exists. In a case where the result of this determination is negative, Step S4040 is carried out, and in a case where the result of this determination is affirmative, Step S4050 is carried out. In this example, in a case where the information obtained in Step S4020 is NULL, Step S4040 is carried out, and in a case where the information obtained in Step S4020 is something other than NULL, Step S4050 is carried out.

In Step S4040, the program 41005 notifies the user of a warning message via the UI provided by the configuration management program 41003.

In Step S4050, the program 41005 instructs the volume migration program 12108 to perform a volume migration from the migration-targeted virtual volume 11100 (2) identified in Step S4010 (the virtual volume 11100 (2) for which the migration flag 410017 is ON (1)) to the migration-destination real volume 11100 (1) identified in Step S4020. At the time of this instruction, the information of the migration-targeted virtual volume 11100 (2) (for example, the storage subsystem ID and the LUN) and the information of the migration-destination real volume 11100 (1) (for example, the storage subsystem ID and the LUN) are sent to the volume migration program 12108. In accordance with this, the volume migration program 12108 is able to identify the migration-targeted virtual volume 11100 (2) and the migration-destination real volume 11100 (1).

In Step S4060, the program 41005 determines whether or not all the virtual volumes 11100 (2) have been checked. In a case where the result of this determination is negative, Step S4020 is carried out, and in a case where the result of this determination is affirmative, Step S4070 is performed.

In Step S4070, the program 41005 waits for a fixed period of time. Thereafter, Step S4010 is carried out. The time period that the migration instruction program 41005 waits in this Step may be set beforehand and changed on a timely basis by the user.

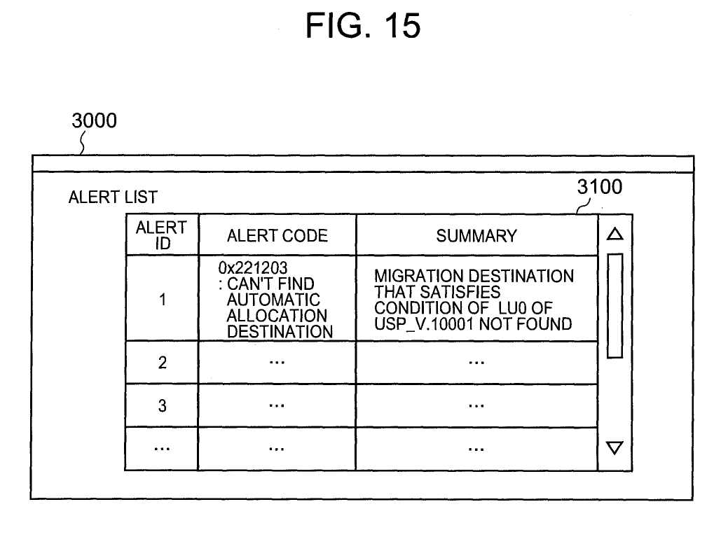

FIG. 15 shows the UI 3000 that is displayed in Step S4040.

The UI 3000 comprises an alert list table 3100 that displays a list of alerts. In this example, the user is able to confirm via the table 3100 that the volume migration with respect to the migration-targeted virtual volume 11100 (2) was not completed.

### <Migration Destination Determination Process>

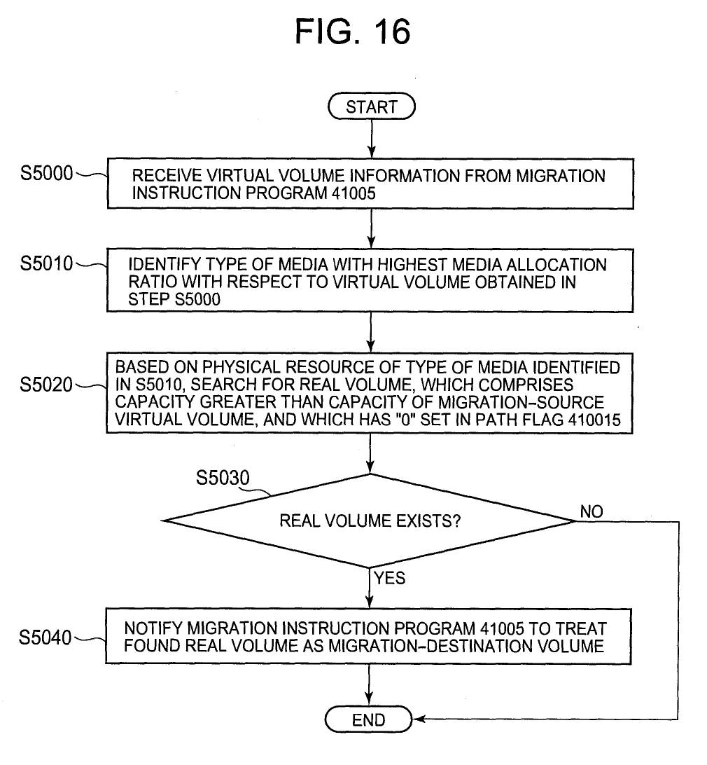

FIG. 16 shows the sequence of the migration destination determination process.

In Step S5000 of this process, the migration destination determination program 41006 receives information of the migration-targeted virtual volume 11100 (2) (hereinafter, referred to as the “target VVOL” in the explanation of FIG. 16) from the migration instruction program 41005. The information here, for example, comprises the storage subsystem ID and the LUN.

In Step S5010, the program 41006 identifies the media type with the highest media allocation ratio with respect to the target VVOL and the capacity of the target VVOL by using the information obtained in Step S5000 to reference the configuration information table 41001.

In Step S5020, the program 41006 searches for the appropriate migration-destination real volume 11100 (1). In this example, the appropriate migration-destination real volume 11100 (1) is the real volume 11100 (1), which is based on the physical resource 11201 of the media type identified in Step S5010, comprises a capacity that is equal to or larger than the capacity (the target VVOL capacity) identified in Step S5010, and, in addition, has a path flag 410015 that is OFF (0).

In Step S5030, the migration destination determination program 41006 determines whether or not an appropriate logical volume was found. In a case where the result of this determination is affirmative, Step S5040 is carried out. In this example, in a case where the result of this determination is negative, the program 41006 notifies the migration instruction program 41005 of a NULL.

In Step S5040, the program 41006 notifies the migration instruction program 41005 of the information of the appropriate migration-destination real volume 11100 (1) that was found.

### <Volume Migration Process>

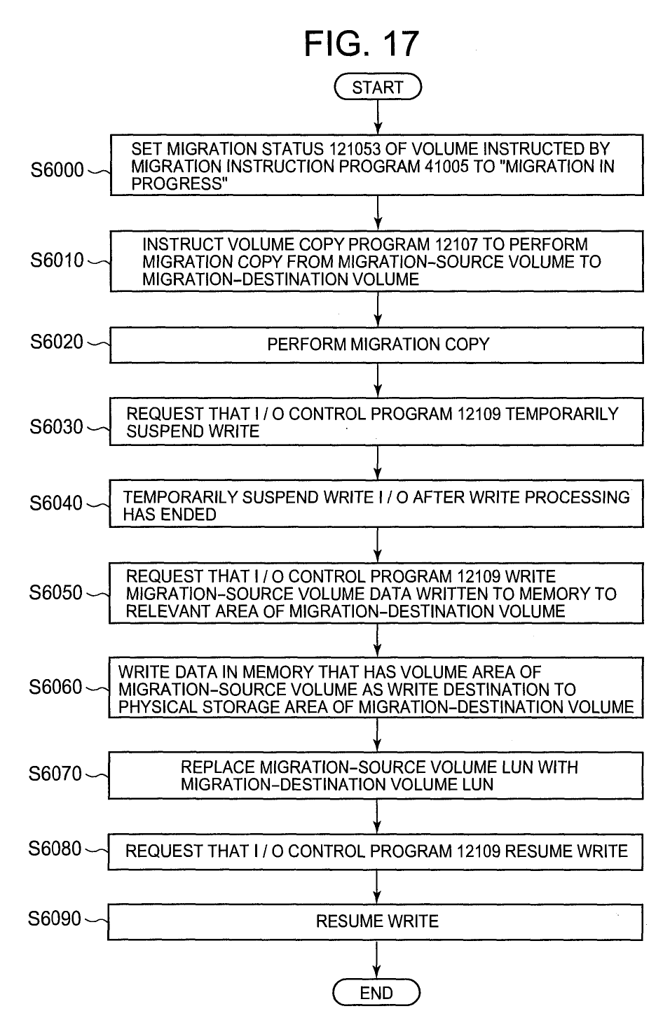

FIG. 17 shows the sequence of a volume migration process.

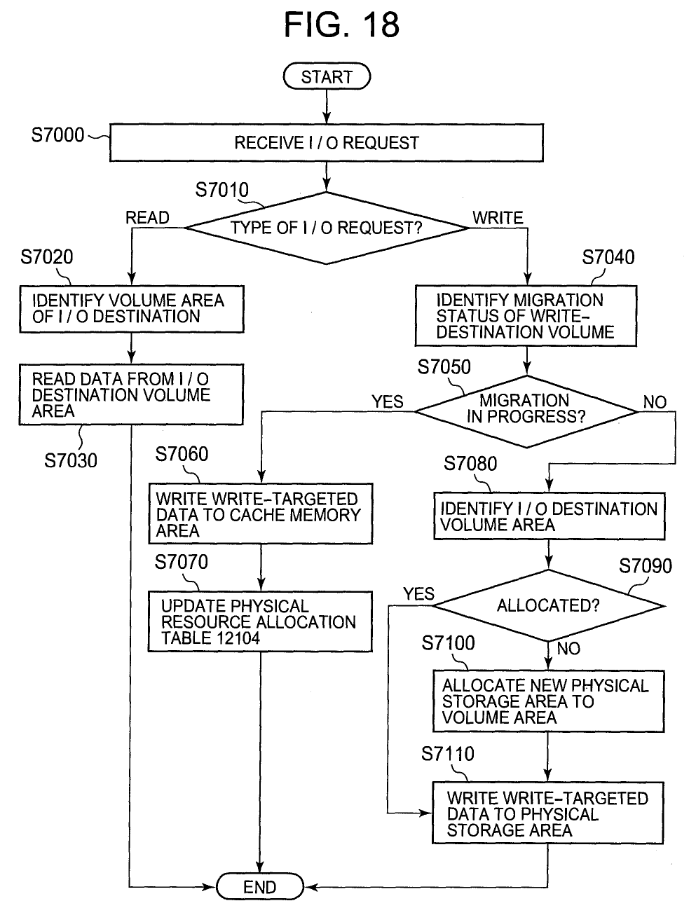

In Step S6000 of this process, first the volume migration program 12108 references the volume allocation table 12105, and sets the migration status 121053 corresponding to the migration-targeted virtual volume 11100 (2), which was specified from the migration instruction program 41005, to “migration in progress”. In accordance with this, as shown in FIG. 18, a write to this virtual volume 11100 (2) is controlled by the I/O control program 12109 so as to be performed this point in time or later to the memory 12100 (the cache memory area) instead of to this virtual volume 11100 (2).

Next, in Step S6010, the program 12108 instructs the volume copy program 12107 to perform a volume copy from the migration-targeted virtual volume 11100 (2) to the migration-destination real volume 11100 (1).

Next, in Step S6020, the volume copy program 12107 copies data from the migration-source virtual volume 11100 (2) to the migration-destination real volume 11100 (1). Specifically, the data inside all the segments allocated to the migration-source virtual volume 11100 (2) is copied to the migration-destination real volume 11100 (1).

Next, in Step S6030, the volume migration program 12108 requests that the I/O control program 12109 temporarily suspend write operations to the migration-source virtual volume 11100 (2).

Next, in Step S6040, the I/O control program 12109, after ending the write processing that is currently in progress, temporarily suspends write operations. In this example, the storage subsystem 10000 is able to receive an I/O request (a read request and a write request) from the host computer 20000 and hold this I/O request in the memory 12100 even while write operations are suspended.

Next, in Step S6050, the volume migration program 12108 requests that the I/O control program 12109 write the data that has been written to the cache memory area in relation to the migration-source virtual volume 11100 (2) to the relevant area of the migration-destination real volume 11100 (1). As used here, “the relevant area” is the area identified from the write-destination LBA with respect for the data in the cache memory area.

Next, in Step S6060, the I/O control program 12109 writes the data that has been written to the cache memory area to the relevant area of the migration-destination real volume 11100 (1) in response to the request in Step S6050.

Next, in Step S6070, the volume migration program 12108 references the physical resource allocation table 12104 and transposes the LUN of the migration-destination real volume 11100 (1) with the LUN of the migration-source virtual volume 11100 (2).

Next, in Step S6080, the volume migration program 12108 requests that the I/O control program 12109 resume write operations.

Next, in Step S6090, the I/O control program 12109 resumes write operations in response to the request in Step S6080.

### <I/O Control Process>

In the I/O control process, control is exerted on the I/O from the host computer 20000 to a logical volume 11100.

FIG. 18 shows the sequence of an I/O control process.

In Step S7000 of this process, first the I/O control program 12109 receives an I/O request from the application 21001.

Next, in Step S7010, the I/O control program 12109 identifies the type of I/O request. It is supposed that the I/O request type is either “read” or “write” here.

In a case where the I/O request type is “read”, in Step S7020, the I/O control program 12109 references the volume allocation table 12105 and the physical resource allocation table 12104, and identifies the read-source volume area.

Then, in Step S7030, the I/O control program 12109 reads data from the identified read-source volume area.

In a case where the I/O request type is “write”, in Step S7040, the I/O control program 12109 references the volume allocation table 12105 and identifies the migration status 121053 corresponding to the write-destination logical volume 11100.

Next, the I/O control program 12109, in Step S7050, determines whether or not the identified migration status 121053 is “migration in progress”.

In a case where the migration status 121053 is “migration in progress”, in Step S7060, the I/O control program 12109 writes the write-targeted data that accords with the write request from the application 21001 to the cache memory area. The write destination here may be a storage area other than the cache memory area.

In Step S7070, the I/O control program 12109 writes the identifier of the cache memory area as the physical resource ID 121044 corresponding to the write-destination volume area, and writes the write-destination address in the cache memory area as the physical LBA 121045 corresponding to the write-destination volume area.

In a case where the migration status 121053 is not “migration in progress”, in Step S7080, the I/O control program 12109 references the volume allocation table 12105 and the physical resource allocation table 12104, and identifies the volume LBA 121042 that conforms to the write-destination LBA.

Next, in Step S7090, the I/O control program 12109 determines whether or not a valid value is already stored as the physical LBA 121045 corresponding to the volume LBA 121042 identified in Step S7080.

In a case where the result of the determination in Step S7090 is affirmative, in Step S7110, the I/O control program 12109 writes the write-targeted data from the application 21001 to the physical storage area shown in the physical LBA 121045 corresponding to the volume LBA 121042 identified in Step S7080.

In a case where the result of the determination in Step S7090 is negative, in Step S7100, the I/O control program 12109 allocates a physical storage area (a segment) based on a new physical resource to the volume area (the virtual area) shown in the volume LBA 121042 identified in Step S7080. The method for determining the newly allocated physical storage area is one that searches the LBA of a physical resource from the start and selects the first area that satisfies the required capacity, but the present invention is not limited to this method in particular. After Step S7100, Step S7110 is carried out.

The processing shown in FIGS. 18, 19 and 20 is carried out for a dynamic reallocation-targeted virtual volume 11100 (2) inside the storage subsystem 10000.

### <Segment Migration Instruction Process>

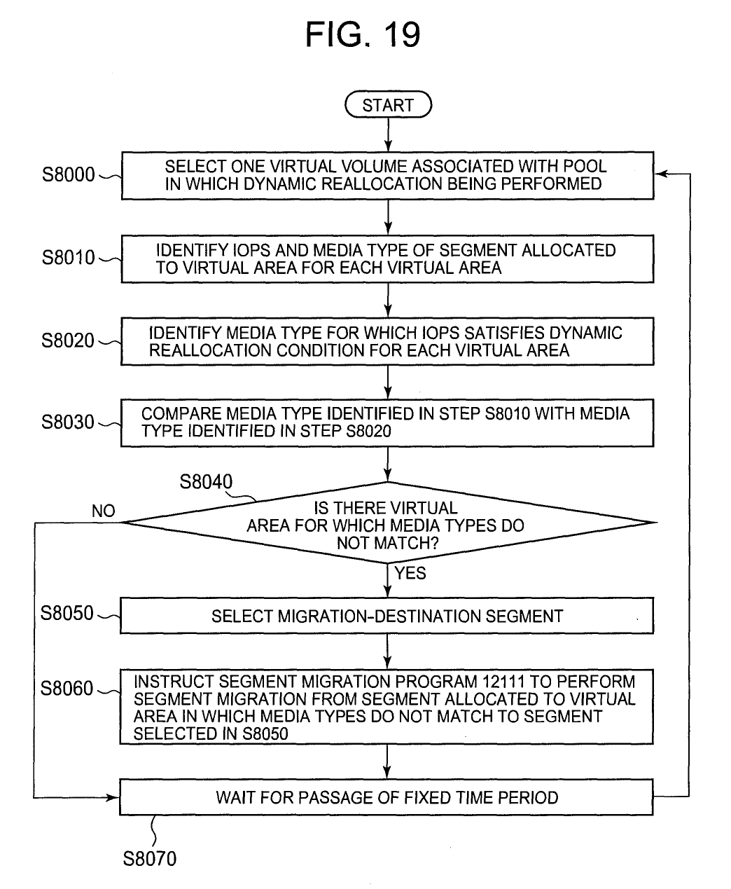

FIG. 19 shows the sequence of a segment migration instruction process.

In Step S8000 of this process, first the segment migration instruction program 12112 selects one virtual volume 11100 (2) that is associated with the dynamic reallocation-targeted pool based on the volume table 12101 and the pool table 12102. Hereinafter, this virtual volume 11100 (2) will be referred to as the “target VVOL” in the explanation of FIG. 19.

Next, in Step S8010, the program 12112 identifies the access frequencies (IOPS) and the media types of the allocated segments with respect to the respective virtual areas of the target VVOL based on the physical resource table 12103 and the physical resource allocation table 12104.

Next, in Step S8020, the program 12112 identifies the media type for which the access frequency satisfies the dynamic reallocation condition with respect to the respective virtual areas of the target VVOL based on the access frequency identified in Step S8010 and the pool table 12102.

Next, in Step S8030, the program 12112 compares the media type identified in Step S8010 with the media type identified in Step S8020 with respect to the respective virtual areas of the target VVOL.

Next, in the Step S8040, the program 12112 determines whether or not there is a segment that is allocated to a virtual area corresponding to media types that are mutually incompatible. In a case where the result of this determination is negative, Step S8070 is carried out, and in a case where the result of this determination is affirmative, Step S8050 is carried.

In Step S8050, the program 12112 selects a migration-destination segment based on the physical resource allocation table 12104 and the pool table 12102. The migration-destination segment is based on the physical resource that corresponds to the dynamic reallocation condition to which the access frequency of the virtual area corresponding to the mutually incompatible media types conforms.

In Step S8060, the program 12112 instructs the segment migration program 12111 to perform a segment migration from the migration-source segment (the segment that is allocated to the virtual area corresponding to the mutually incompatible media types) to the migration-destination segment (the segment selected in Step S8040). The information of the migration-source segment (for example, the pool ID, the physical resource ID, and the physical LBA) and the information of the migration-destination segment (for example, the pool ID, the physical resource ID, and the physical LBA) may be sent to the segment migration program 12111 at the time of this instruction. In accordance with this, the segment migration program 12111 is able to identify the migration-source segment and the migration-destination segment.

Next, in Step S8070, the segment migration instruction program 12112 waits for a fixed period of time. Thereafter, Step S8000 is carried out once again. The time that the segment migration instruction program 12112 waits in this Step may be set beforehand and changed on a timely basis by the user. Further, in this example, a determination based on the access frequency is made as to whether or not there is conformance with the dynamic reallocation condition, but another attribute value, such as the response time of the logical volume (for example, the length of time from the reception of an I/O request that specifies the logical volume until a response is returned to the host computer 20000) may be used either instead of or in addition to the access frequency.

### <Segment Migration Process>

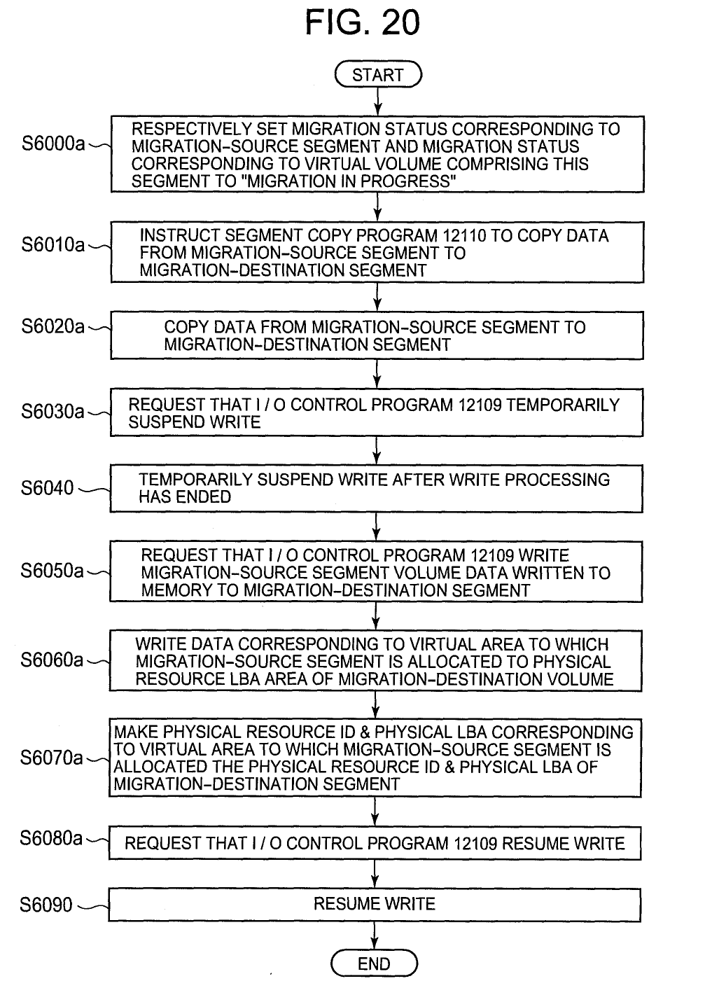

FIG. 20 shows the sequence of a segment migration process. Since Steps S6040 and S6090 of this processing are the same as Steps S6040 and S6090 of the volume migration shown in FIG. 17, an explanation of these Steps will be omitted.

In Step S6000a of this process, first the segment migration program 12112 references the volume allocation table 12105 and the physical resource table 12104, and carries out the following (1) and (2):

(1) Sets the migration status 121046 corresponding to the migration-source segment instructed from the segment migration instruction program 12112 to “migration in progress”; and
(2) Sets the migration status 121053 corresponding to the virtual volume 11100 (2) comprising the migration-source segment to “migration in progress”.

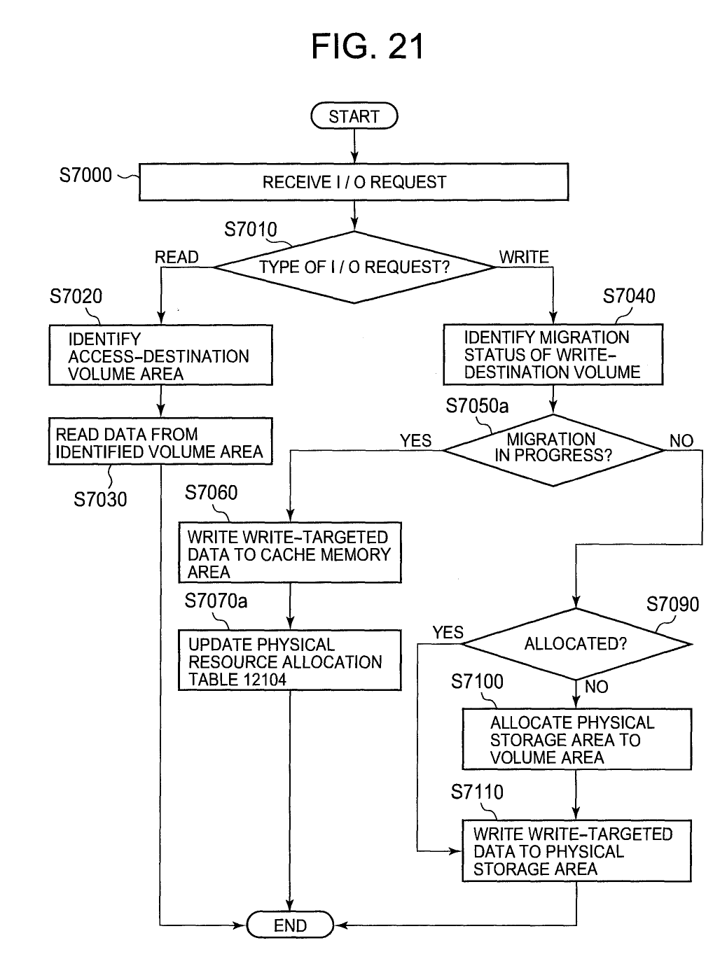

In accordance with this, as shown in FIG. 21, a write to this segment (and the virtual volume 11100 (2) comprising this segment) is controlled by the I/O control program 12109 so as to carried out to the cache memory area instead of to this segment at this point in time and after. Furthermore, the above-cited (2) need not be carried out.

Next, in Step S6010a, the segment migration program 12112 instructs the segment copy program 12110 to copy the data from the migration-source segment to the migration-destination segment.

Next, in Step S6020a, the segment copy program 12110 copies the data from the migration-source segment to the migration-destination segment in response to the instruction in Step S6010a.

Next, in Step S6030a, the segment migration program 12112 requests that the I/O control program 12109 temporarily suspend write operations to the virtual area to which the migration-source segment is allocated.

In Step S6050a, the segment migration program 12111 requests that the I/O control program 12109 write the data that has been written to the cache memory area to the migration-destination segment with respect to the virtual area to which the migration-source segment is allocated.

Next, in Step S6060a, the I/O control program 12109 writes the data, which has the virtual area to which the migration-source segment is allocated as the write destination, from the cache memory area to the migration-destination segment in response to the request of Step S6050a.

Next, in Step S6070a, the segment migration program 12111 references the physical allocation table 12104 and updates the physical resource ID 121044 and physical LBA 121045 corresponding to the virtual area to which the migration-source segment is allocated to the physical resource ID and physical LBA of the migration-destination segment.

Next, in Step S6080a, the segment migration program 12112 requests that the I/O control program 12109 resume write operations.

### <Segment-Unit I/O Control Process>

FIG. 21 shows the sequence of a segment-unit I/O control process. Steps S7000, S7010, S7020, S7030, S7040, S7060, S7090, S7100, and S7110 of this process are the same as Steps S7000, S7010, S7020, S7030, S7060, S7090, S7100, and S7110 of the I/O control process shown in FIG. 18, and as such, explanations of these Steps will be omitted.

In Step S7050a of this process, the I/O control program 12109 determines whether or not the migration status 121046 corresponding to the I/O-destination virtual area is “migration in progress”. In a case where the result of this determination is affirmative, Step S7060 is carried out, and in a case where the result of this determination is negative, Step S7090 is carried out.

In Step S7070a, the I/O control program 12109 writes the identifier of the cache memory area to the physical resource allocation table 12104 as the physical resource ID 121044 corresponding to the write-destination virtual area, and writes the write-destination address in the cache memory area as the physical LBA 121045 corresponding to the write-destination virtual area.

The preceding has been an explanation of the processing carried out in Example 1. According to the above explanation, a virtual volume 11100 (2) for which dynamic reallocation is considered ineffective is identified, and the data inside this migration-targeted virtual volume 11100 (2) is migrated to a real volume 11100 (1). The migration-destination real volume 11100 (1) is the real volume 11100 (1) that is based on a physical resource 11201 of the same media type as the media type with the highest media allocation ratio with respect to the migration-targeted virtual volume 11100 (2). For example, in a case where the media allocation ratio corresponding to SSD is 90% and the media allocation ratio corresponding to SATA is 10% with respect to the migration-targeted virtual volume 11100 (2), the migration-destination real volume 11100 (1) is the real volume 11100 (1) that is based on the SSD. For this reason, it is possible to allocate the data inside the virtual volume 11100 (2) to the appropriate real volume 11100 (1) that corresponds to the media allocation ratio of each media type with respect to this virtual volume 11100 (2). Also, since the segment that has been allocated to this virtual volume 11100 (2) is allocatable to all the other virtual volumes 11100 (2), the pool 11200 can be used effectively.

The virtual volume 11100 (2) for which dynamic reallocation is considered ineffective is determined by the migration policy, and it is preferable that this policy be defined in accordance with the following point of view.

For example, in a case where the media allocation ratio corresponding to a certain media type (for example, SSD) remains high for a long period of time with respect to the virtual volume 11100 (2), storing the data inside the virtual volume 11100 (2) in the real volume 11100 (1) is considered preferable to storing this data in the virtual volume 11100 (2). This is because the allocation of most of the data inside the virtual volume 11100 (2) in this case is not changed in a dynamic reallocation, and therefore, the dynamic reallocation is ineffective. It is also because, generally speaking, an I/O to a virtual volume that conforms to Thin Provisioning requires processing for finding the segment that corresponds to the I/O-destination virtual area, and for this reason, constitutes a higher load than an I/O to a real volume, and continuing to allocate data for which dynamic reallocation is ineffective to the pool 11200 despite this fact wastefully lowers I/O performance, and, in addition, wastefully uses up the pool 11200.

Therefore, it is preferable that a condition, which signifies that the media allocation ratio is biased, and a condition for a time period during which this bias continues be included as the migration policy.

### Example 2

Example 2 of the present invention will be explained below. The differences with the Example 1 will mainly be explained hereinbelow, and explanations for the points in common with the Example 2 will be either simplified or omitted.

### <Overview of Example 2>

In Example 2, the migration-destination real volume 11100 (1) is determined on the basis of the media allocation ratio for each media type with respect to the migration-targeted virtual volume 11100 (2).

### <Configuration of Data Processing System Related to Example 2>

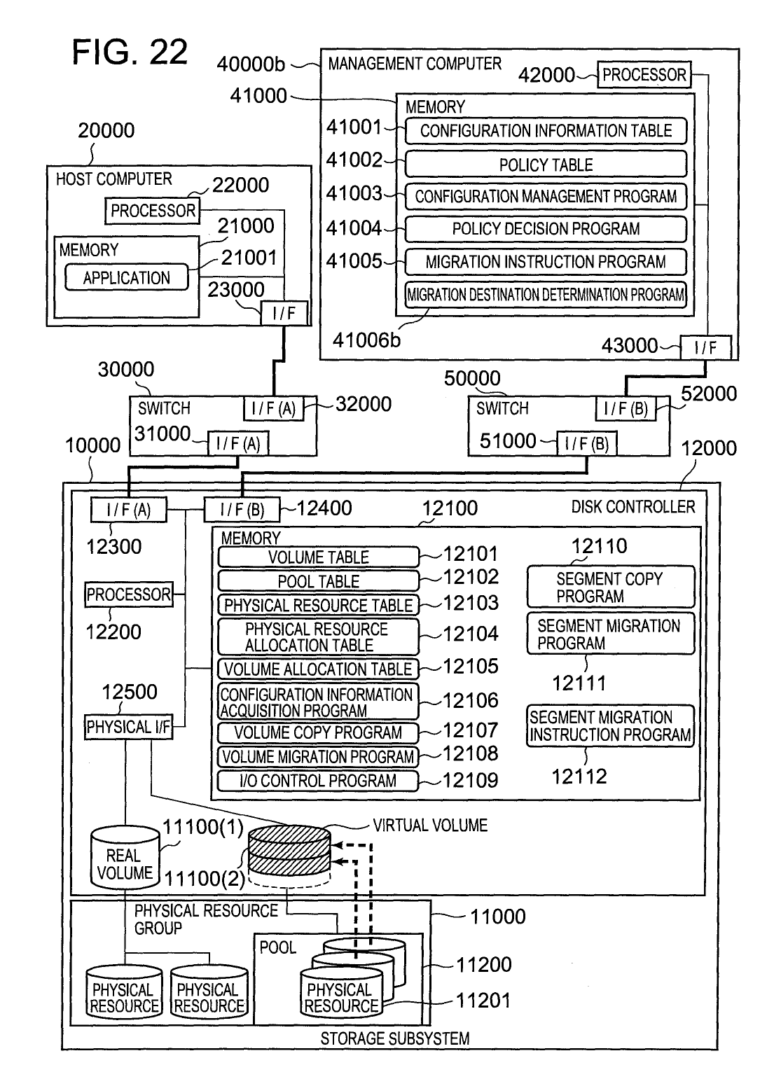

FIG. 22 shows the configuration of a data processing system related to Example 2 of the present invention.

In this data processing system, a management computer 40000b differs from the management computer 40000 in Example 1. Specifically, a migration destination determination program 41006b differs from the migration destination determination program 41006 of Example 1. The migration destination determination program 41006b determines the migration-destination real volume 11100 (1) based on the media allocation ratio of each media type with respect to the migration-targeted virtual volume 11100 (2).

### <Migration Destination Determination Process Related to Example 2>

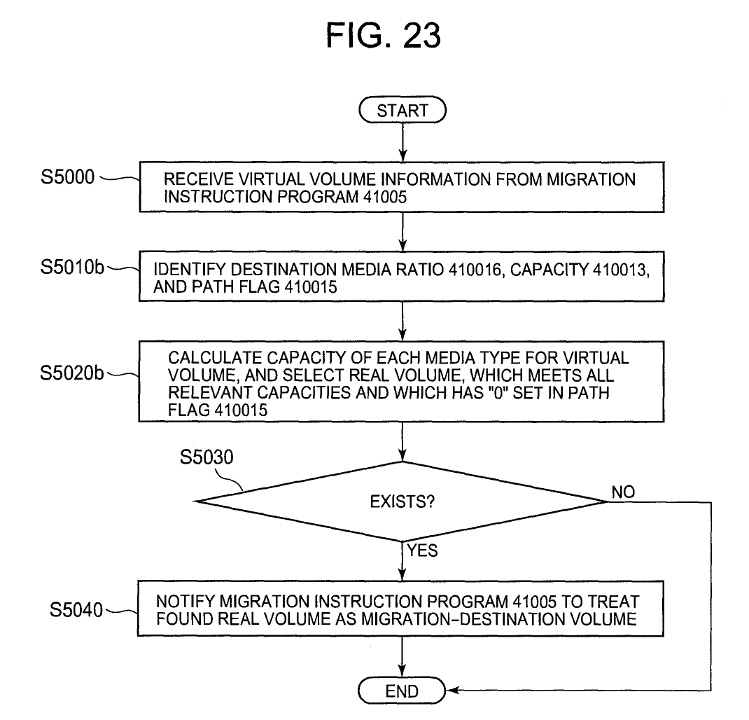

FIG. 23 shows the sequence of a migration destination determination process related to Example 2.

Since Steps S5000, S5030, and S5040 of FIG. 23 are the same as processing of Steps S5000, S5030, and S5040 of the migration destination determination process of FIG. 16, explanations of these Steps will be omitted.

In Step S5010b of the migration destination determination process related to this example, the migration destination determination program 41006b identifies the allocation-destination media breakdown 410016 and the capacity 410013 corresponding to the target VVOL (the migration-targeted virtual volume 11100 (2)) by using the information obtained in Step S5000 to reference the configuration information table 41001.

In Step S5020b, the program 41006b references the configuration information table 41001 and calculates the capacity for each media type with respect to the target VVOL based on the capacity 410013 and the allocation-destination media breakdown 410016 identified in Step S5000. Next, the program 41006b selects as the migration-destination real volume 11100 (1) a real volume 11100 (1) for which the capacity of the physical storage area of the respective media types is equal to or larger than the calculated capacity for each media type, and, in addition, the path flag 410015 is OFF (0). Specifically, the following processing is carried out in accordance with this Step S5020b.

(*) It is supposed that the capacity 410013 identified in Step S5000 is shown as 1000 GB, and the allocation-destination media breakdown 410016 is shown as SSD: 20%, SAS: 30%, and SATA: 50%. In accordance with this, SSD: 200 GB, SAS: 300 GB, and SATA: 500 GB are calculated as the capacities of each of the media types.
(*) A real volume 11100 (1) that is configured based on physical storage areas of SSD: equal to or larger than 200 GB, SAS: equal to or larger than 300 GB, and SATA: equal to or larger than 500 GB is determined as the migration-destination real volume 11100 (1).

The preceding has been an explanation of Example 2. According to Example 2, the migration destination of data from the virtual volume 11100 (2) for which dynamic reallocation is considered ineffective becomes a real volume 11100 (1) that has a configuration that most closely resembles the configuration (the media allocation ratio of each media type) of this virtual volume 11100 (2). For this reason, more appropriate data allocation can be expected.

### Example 3

Example 3 of the present invention will be explained below. The differences with Example 2 will mainly be explained hereinbelow, and explanations for the points in common with Example 2 will be either simplified or omitted.

### <Overview of Example 3>

In Example 3, the migration-destination real volume 11100 (1) is determined not only on the basis of the media allocation ratio and capacity of the migration-targeted virtual volume 11100 (2), but also on the performance of this virtual volume 11100 (2). As used here, “performance”, for example, is the I/O rate (the amount of data that is inputted/outputted per unit of time).

### <Configuration of Data Processing System Related to Example 3>

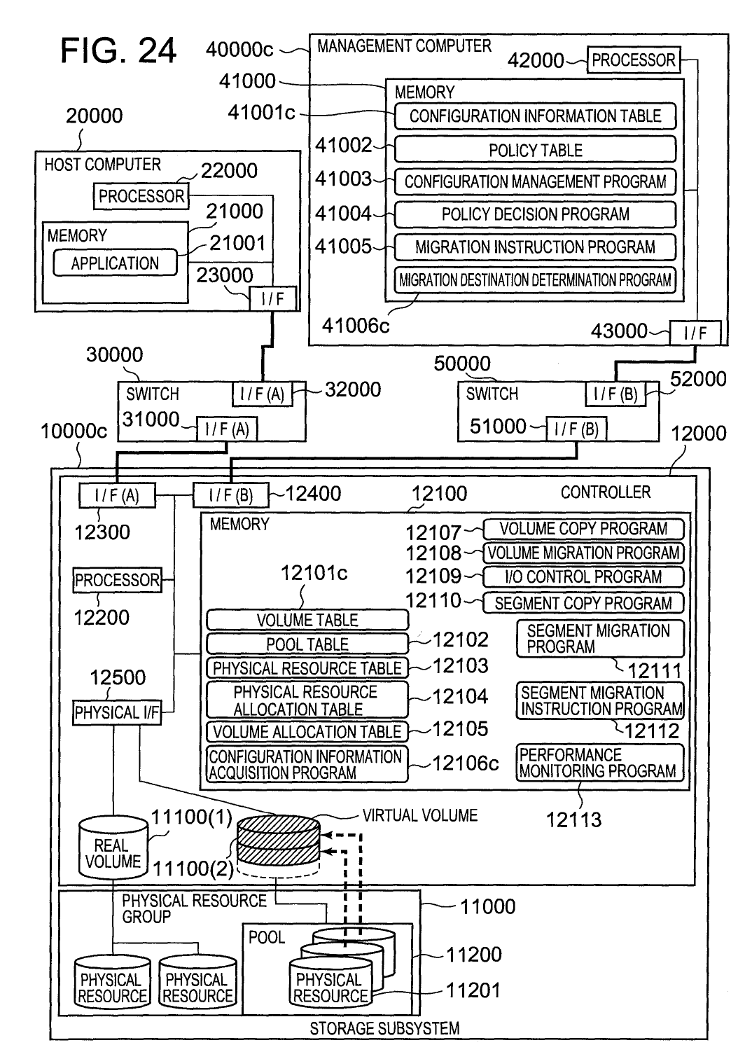

FIG. 24 shows the configuration of a data processing system related to Example 3 of the present invention.

In this data processing system, a storage subsystem 10000c differs from the storage subsystem 10000 in Example 2. Specifically, the following is different.

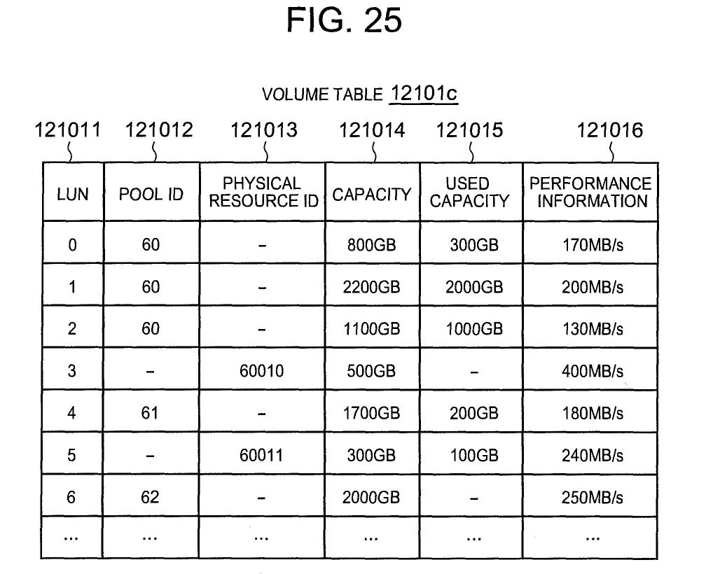

(*) A volume table 12101c differs from the volume table 12101 in Example 2. The configuration of the volume table 12101c is shown in FIG. 25. According to FIG. 25, the table 12101c further comprises performance information 121016 for each logical volume 11100. The performance information 121016 shows the performance (the I/O rate) of the logical volume 11100. In the example of FIG. 25, the performance is shown as “MB/s” (megabytes/second), but the expression for performance is not limited to this, and a different unit or index that denotes logical volume 11100 performance information may be used.
(*) A performance monitoring program 12113 is newly provided. The performance monitoring program 12113 regularly identifies the performance of the respective logical volumes 11100, and registers information denoting the identified performance as the performance information 121016 of the table 12101c shown in FIG. 2. A configuration information acquisition program 12106c differs from the configuration information acquisition program 12106 in Example 2. The configuration information acquisition program 12106c acquires configuration information comprising information that shows the performance information 121016, and sends this configuration information to the management computer 40000c.

In this data processing system, the management computer 40000c differs from the management computer 40000b in Example 2. Specifically, the differences are as follows.

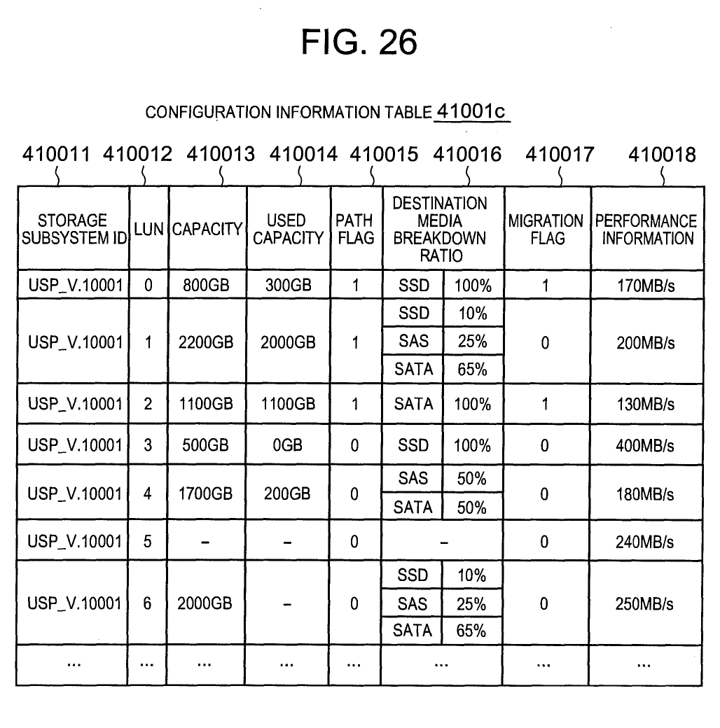

(*) A configuration information table 41001c differs from the configuration information table 41001 of Example 2. The configuration of the configuration information table 41001c is shown in FIG. 26. According to FIG. 26, the table 41001c further comprises performance information 410018 for each logical volume 11100. The performance information 410018 shows the performance (the I/O rate) of the logical volume 11100. This information 410018 shows information identified from the configuration information.
(*) A migration destination determination program 41006c differs from the migration destination determination program 41006b of Example 2. The migration destination determination program 41006c determines the migration-destination real volume 11100 (1) based not only on the media allocation ratio and capacity of the migration-targeted virtual volume 11100 (2), but also on the performance (the performance expressed by the performance information 410018) of this virtual volume 11100 (2).

### <Configuration Information Acquisition Process Related to Example 3>

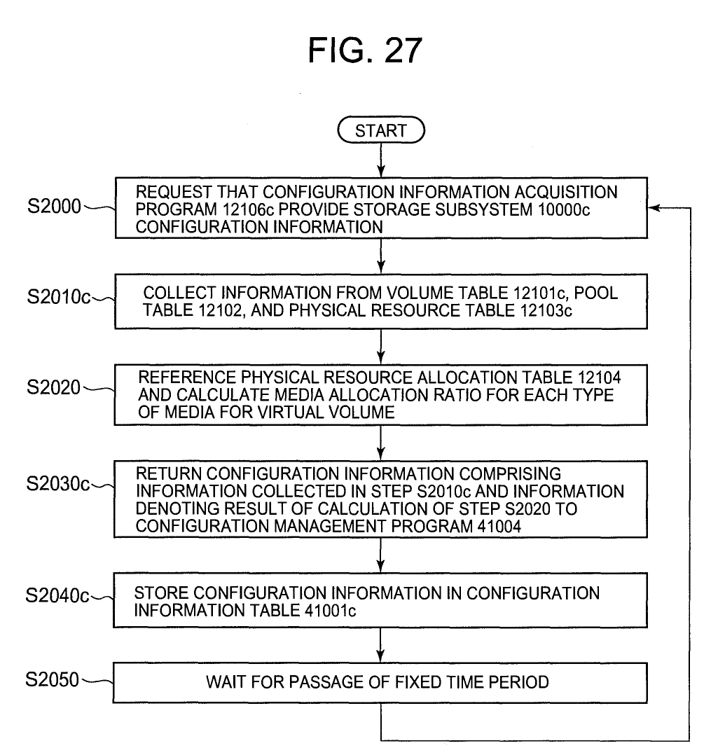

FIG. 27 shows the sequence of a configuration information acquisition process related to Example 3.

Since Steps S2000, S2020, and S2050 of this process are the same as Steps S2000, S2020, and S2050 shown in FIG. 12, explanations of these Steps will be omitted.

In Step S2010c of this process, the configuration information acquisition program 12106c collects information (including information shown by the performance information 121016 of the logical volume 11100) shown in a volume table 12101c, the pool table 12102 and a physical resource table 12103c.

In Step S2030c, the program 12106c returns configuration information comprising the information collected in Step S2010c and the information acquired in Step S2020 to the configuration management program 41003.

In Step S2040c, the configuration management program 41003 stores the configuration information (including the performance information) of the storage subsystem 10000c in a configuration information table 41001c.

### <Volume Performance Monitoring Process>

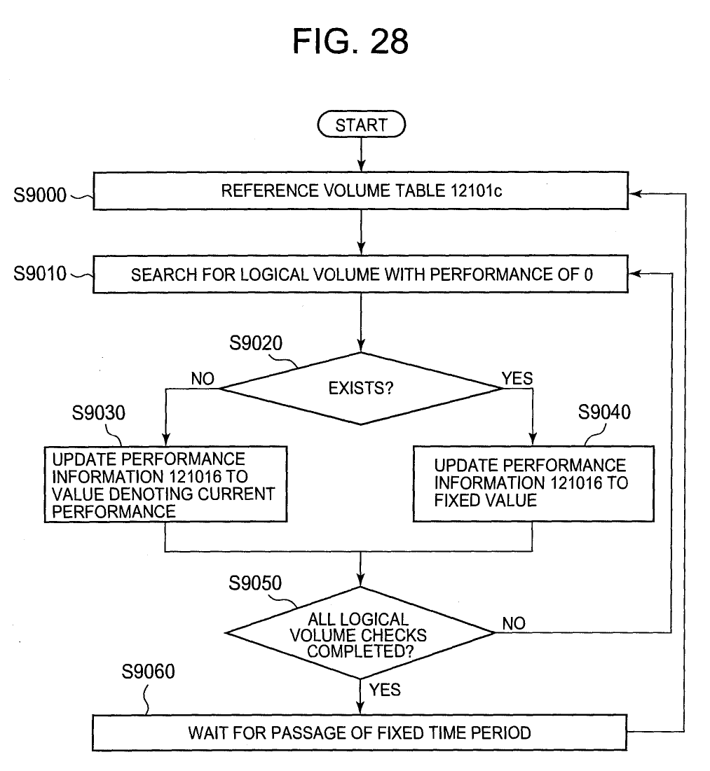

FIG. 28 shows the sequence of a volume performance monitoring process.

In Step S9000 of this process, the performance monitoring program 12113 references the volume table 12101c.

In Step S9010, the performance monitoring program 12113 selects from the volume table 12101c one logical volume 11100 that was not checked in the loop from Step S9010 to Step S9050, and identifies the performance information 121016 corresponding to the selected logical volume (referred to as the “selected volume” hereinafter in the explanation of FIG. 28) 11100.

In Step S9020, the program 12113 determines whether or not the identified performance information 121016 shows 0 MB/s. In a case where the result of this determination is negative, Step S9030 is carried out, and in a case where the result of this determination is affirmative, Step S9040 is carried out.

In Step S9030, the program 12113 updates the performance information 121016 corresponding to the selected volume 11100 to the information showing the current performance of the selected volume 11100 (for example, the value that was actually measured).

In Step S9040, the program 12113 updates the performance information 121016 corresponding to the selected volume 11100 to a fixed value that conforms to the selected volume 11100. The fixed value that conforms to the selected volume 11100, for example, may be an expected performance calculated on the basis of specifications that correspond to the media type that is the basis of the selected volume 11100, and may be a value predicted by the user (storage administrator).

In Step S9050, the program 12113 determines whether the check of all the logical volumes 11100 has ended. In a case where the result of this determination is negative, Step S9010 is carried out, and in a case where the result of this determination is affirmative, Step S9060 is carried out.

In Step S9060, the program 12113 waits for a fixed period of time. Thereafter, Step S9000 is carried out. The period of time that the performance monitoring program 12113 waits in this step may be established beforehand and changed on a timely basis by the user (storage administrator).

### <Migration Destination Determination Process Related to Example 3>

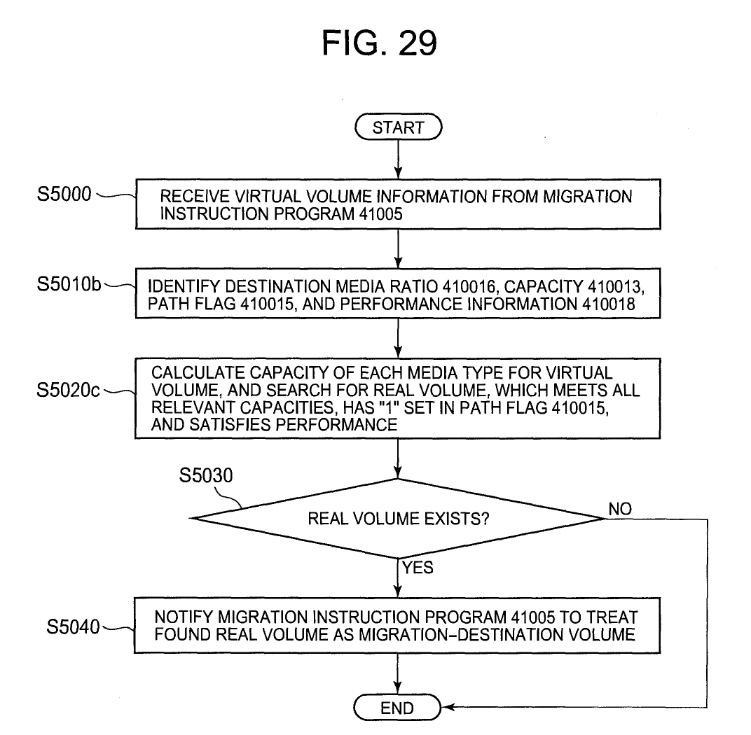

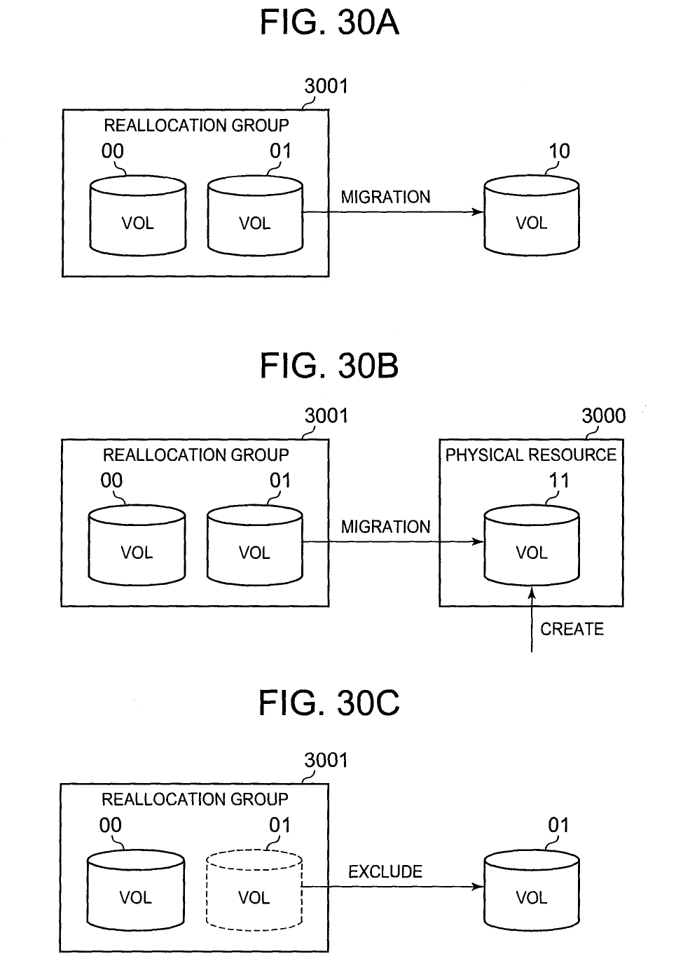

FIG. 29 shows the sequence of a migration destination determination process related to Example 3.

Since Steps S5000, S5010b, S5030, and S5040 of this process are the same as Steps S5000, S5010b, S5030, and S5040 of FIG. 25, explanations of these Steps will be omitted.

In Step S5020c of this process, the migration destination determination program 41006c references the configuration information table 41001c, and, based on the capacity 410013 and the allocation-destination media breakdown 410016 identified in S5000, calculates the capacity of each media type with respect to the target VVOL (the migration-targeted virtual volume 11100 (2)). Next, the program 41006c selects as the migration-destination real volume 11100 (1) a real volume 11100 (1) for which the capacity of the physical storage areas of the respective media types is equal to or larger than the calculated capacity for each media type, the path flag 410015 is OFF (0) and, in addition, performance is equal to or greater than that of the target VVOL.

The preceding has been an explanation of Example 3. According to Example 3, the migration destination of data from a virtual volume 11100 (2) for which dynamic reallocation is considered ineffective is a real volume 11100 (1), which comprises a configuration that most closely resembles the configuration (the media allocation ratio for each media type) of this virtual volume 11100 (2), and, in addition, comprises performance equal to or greater than the performance of this virtual volume 11100 (2). For this reason, more appropriate data allocation can be expected.

A number of examples of the present invention have been explained hereinabove, but the present invention is not limited to these examples, and it goes without saying that various changes are possible within a scope that does not depart from the gist thereof.

For example, as the condition of the migration-destination real volume 11100 (1) determined in Example 2 and Example 3, a capacity that is equal to or greater than the capacity of the migration-targeted virtual volume 11100 (2) may be used. Further, the condition of the migration-destination real volume 11100 (1) determined in Example 3 may use the fact that this real volume 11100 (1) is based on the physical resource 11201 of the same media type as the media type with the highest media allocation ratio related to the migration-targeted virtual volume 11100 (2) instead of comprising a capacity that is equal to or greater than the capacity for each media type with respect to the respective media types.

The media allocation ratio may be the extent of the capacity (overall) of the virtual volume 11100 (2) accounted for by the segment of a certain media type.

Further, the migration destination is not limited to a real volume 11100 (1), but rather a virtual volume 11100 (2) may also be determined as the migration destination. However, it is preferable that the dynamic reallocation condition with respect to the pool (hereinafter, the migration-destination pool) 11200 that is associated with the migration-destination virtual volume 11100 (2) at this time differ from the dynamic reallocation condition with respect to the pool (hereinafter, migration-source pool) 11200 that is associated with the migration-targeted virtual volume 11100 (2). This is because, in a case were these dynamic reallocation conditions differ from one another, there is the likelihood that the data inside the migration-destination virtual volume 11100 (2) will be migrated within the migration-destination pool 11200 by a dynamic reallocation with respect to the migration-destination virtual volume 11100 (2) subsequent to a volume migration between the virtual volumes 11100 (2). That is, the effects of the dynamic reallocation can be expected to be achieved.

Further, the migration-targeted logical volume 11100 is not limited to a virtual volume 11100 (2), but rather may also be a real volume 11100 (1). For example, after a volume migration that has a certain real volume 11100 (1) as the migration destination has been performed, there is the likelihood of access frequency being biased toward the plurality of volume areas that configure this certain real volume 11100 (1). For this reason, the I/O control program 12109 may also monitor access frequency with respect to the respective volume areas of the real volume. Then, in a volume migration, data may be migrated from a volume area inside the real volume 11100 (1) to a virtual area inside a virtual volume 11100 (2) (a virtual area that belongs to the address corresponding to the address of the migration-source volume area). A segment based on a physical resource 11201 with an access frequency range, to which the access frequency of the migration-source volume area belongs, may be allocated to the migration-destination virtual volume at this time.

Further, the migration-source logical volume 11100 and the migration-destination logical volume 11100 may exist in different storage subsystems. In accordance with this, a migration instruction from the management computer may be sent to the storage subsystem comprising the migration-source logical volume (hereinafter, the migration-source subsystem), and may also be sent to the storage subsystem comprising the migration-destination logical volume (hereinafter, the migration-destination subsystem). In accordance with this, a storage system is configured from the plurality of storage subsystems. In the storage system, a migration between the storage subsystems may be performed by the migration-source subsystem sending a request (for example, a write request) to the migration-destination subsystem, and may also be performed by the migration-destination subsystem sending a request (for example, a read request) to the migration-source subsystem.

Further, a dynamic reallocation may be carried out in logical volume units rather than segment units. For example, in a case where the I/O state (for example, the access frequency, the response time, or the time elapsed since the last I/O time) of a first logical volume does not conform to the dynamic reallocation condition (the condition related to the I/O state) corresponding to the media type of a first physical resource that constitutes the basis of the first logical volume, the data inside the first logical volume may be migrated to a second logical volume based on a second physical resource to which is associated a dynamic reallocation condition that is suitable for the I/O state of the first logical volume.

Further, the tables and programs of the management computer 40000 may be executed by either the storage subsystem or the host computer instead of the management computer 40000.

What is claimed is:

1. A management system, which is coupled to a storage system that includes a plurality of types of media and a controller, provides a plurality of logical volumes, and performs a reallocation process,
the management system, comprising:
a storage resource, which stores the following information (1) through (3):
(1) configuration management information, which is information related to a plurality of logical volumes provided by the storage system;
(2) reallocation group information, which is information denoting a reallocation group, which is a group of one or more logical volumes to be subjected to a target of the reallocation process; and
(3) migration policy information, which is information denoting a migration policy, which is a condition under which the reallocation process is considered ineffective; and
a processor, which is coupled to the storage resource,
wherein the reallocation process is a process for migrating data, specified in accordance with a reallocation policy, from media in which this data is stored to media of types differing from the media, and
wherein the processor (A) searches for a logical volume that conforms to a migration policy denoted by the migration policy information from the reallocation group, and (B) causes the storage system to transfer the data in the logical volume discovered in accordance with the (A) to outside the reallocation group.

2. A management system according to claim 1,
wherein a virtual volume, which is configured from a plurality of virtual areas, is included in the plurality of logical volumes,
wherein the storage system has a plurality of types of physical resources, and a pool, which is a storage area configured from the plurality of types of media,
wherein respective types of media are based on the same type of physical resource,
wherein the media type depends on the type of physical resource that constitutes the basis of the media,
wherein the storage system, upon receiving from a host computer an I/O (Input/Output) request in which a virtual area of the virtual volume is specified, allocates a real area to an I/O-destination virtual area from any media in the pool and performs the I/O to the allocated real area in a case where a real area has not been allocated to the I/O-destination virtual area in the virtual volume, and performs the I/O to the real area in a case where this real area has been allocated to the I/O-destination virtual area,
wherein the storage system, upon either receiving an I/O (Input/Output) request in which a virtual area of the virtual volume is specified from a host computer, or performing an I/O to a real area allocated to this virtual area, updates an I/O status of this virtual area,
wherein the storage system performs the reallocation process that includes the processing of (a) and (b) below:
(a) in a case where the I/O status of a first virtual area in the virtual volume does not satisfy an I/O status condition for media having a first real area, which is allocated to the first virtual area, the data in the first real area is migrated to a second real area in media corresponding to an I/O status condition to which the I/O status of the first virtual area conforms; and
(b) instead of the first real area the second real area is allocated to the first virtual area,
wherein the migration policy includes an allocation condition, which is a condition related to the data allocation, and a time period condition, which is a condition related to a period of time during which this allocation condition has continuously been in conformance, and
wherein in the (A), the processor searches for a virtual volume satisfying the time period condition, the time period condition being satisfied by a time period during which a data allocation has been in continuous conformance with the allocation condition.

3. A management system according to claim 2,
wherein a plurality of real volumes of different types are included in the plurality of logical volumes,
wherein each real volume is based on one or more types of physical resources,
wherein the type of the real volume depends on the type of the physical resource on which this real volume is based, and
wherein in the (B), the processor determines a migration-destination real volume based on the data allocation of the virtual volume discovered in the (A), and on the type of the physical resource on which each real volume is based.

4. A management system according to claim 3,
wherein the migration-destination real volume is a real volume based on a physical resource of the same type as the type of media having the largest real area of one or more real areas allocated to the virtual volume discovered in the (A).

5. A management system according to claim 3,
wherein the migration-destination real volume is a real volume in which a capacity of each type of physical resource is equal to or greater than a real capacity of each media type of the virtual volume discovered in the (A), and
wherein the real capacity of the media types is the total storage capacity of one or more real areas that are allocated from the media of the media types.

6. A management system according to claim 3,
wherein the migration-destination real volume is a real volume having I/O performance equal to or greater than I/O performance of the virtual volume discovered in the (A).

7. A management system according to claim 2,
wherein the configuration management information includes information related to a data allocation denoting how much data, of the data in the virtual volume, is allocated to which types of media,
wherein the processing of the (A) is performed either regularly or irregularly,
wherein in the (A), the processor:
(a1) determines whether or not the virtual volume data allocation satisfies the allocation condition based on the configuration management information;
(a2) in a case where the result of the determination in the (a1) is affirmative, determines whether or not the start time, which is the time by which determination is made that the virtual volume data allocation satisfies the allocation condition, is being managed;
(a3) in a case where the result of the determination in the (a2) is negative, manages, as the start time, the time when the allocation condition has been satisfied for the virtual volume, and ends the processing of the (A);
(a4) in a case where the result of the determination in the (a2) is affirmative, determines whether or not an elapsed time from the start time conforms to the time period condition; and
(a5) in a case where the result of the determination of the (a4) is negative, ends the processing of this (A), and
wherein the virtual volume discovered in the (A) is a virtual volume for which the result of the determination of the (a4) has been affirmative.

8. A management system according to claim 2,
wherein the migration policy is established for each virtual volume by a user.

9. A management system according to claim 2,
wherein the migration policy is configured from a plurality of condition sets and a logic condition, which is a condition under which definition is made as to which one or more condition sets of the plurality of condition sets have to be satisfied, and
wherein each of the condition sets is a set to include an allocation condition and a time period condition.

10. A management system according to claim 1,
wherein the migration-destination logical volume is a logical volume having an I/O performance that is equal to or greater than an I/O performance of the logical volume discovered in the (A).

11. A management system according to claim 3,
wherein the migration-destination logical volume is a logical volume in a status where an I/O from the host computer is unable to be performed, and
wherein after a migration, the migration-destination logical volume is transformed to a status an I/O from the host computer can be carried out.

12. A management system according to claim 1,
wherein the storage system has a plurality of physical resources that include two or more physical resources based on the plurality of types of media,
wherein in the (B), the processor specifies from the plurality of physical resources a physical resource that is not related to a logical volume included in the reallocation group, creates a new logical volume based on the specified physical resource, and causes the storage system to store in the newly created logical volume the data in the logical volume discovered in accordance with the (A), and
wherein the logical volume that is not included in the reallocation group is the newly created logical volume.

13. A management system according to claim 1,
wherein in the (B), the processor removes the logical volume discovered in accordance with the (A) from the reallocation group, and
wherein the logical volume, which is not included in the reallocation group, is the logical volume discovered in accordance with the (A) that has been removed from the reallocation group.

14. A computer system, comprising:
a storage system, which includes a plurality of types of media and a controller, provides a plurality of logical volumes, and performs a reallocation process; and
a management system, which is coupled to the storage system,
wherein the reallocation process is a process for migrating data, specified in accordance with a reallocation policy, from media in which this data is stored to media of types differing from the media, and
wherein the management system:
(A) searches for a logical volume that conforms to a migration policy, which is a condition under which the reallocation process is considered ineffective from the reallocation group, which is a group of one or more logical volumes subjected to a target of the reallocation process; and
(B) causes the storage system to transfer the data in the logical volume discovered in accordance with the (A) to outside the reallocation group.

15. A method for controlling allocation of data in a storage system, which includes a plurality of types of media and a controller, provides a plurality of logical volumes, and performs a reallocation process for migrating data specified in accordance with a reallocation policy from media in which this data is stored to media of different types from the media,
the data allocation control method comprising:
(A) searching for a logical volume that conforms to a migration policy, which is a condition under which the reallocation process is considered ineffective, from the reallocation group, which is a group of one or more logical volumes subjected to a target of the reallocation process; and
(B) causing the storage system to output data in the logical volume discovered in accordance with the (A) to a logical volume that is not included in the reallocation group.
